(19) United States
(12) Patent Application Publication
(10) Pub. No.: US 2006/0168259 A1
(43) Pub. Date: Jul. 27, 2006

(54) System and method for accessing data via Internet, wireless PDA, smartphone, text to voice and voice to text

(75) Inventors: Mark Spilotro, Georgetown, TX (US); Xin Chen, Cedar Park, TX (US)

Correspondence Address: WONG, CABELLO, LUTSCH, RUTHERFORD & BRUCCULERI,;P.C., 20333 SH 249, SUITE 600, HOUSTON, TX, 77070, US

(73) Assignee: iKnowWare, LP, Georgetown, TX (US)

(21) Appl. No.: 11/341,768

(22) Filed: Jan. 27, 2006

Related U.S. Application Data
(60) Provisional application No. 60/647,924, filed on Jan. 27, 2005.

(51) Int. Cl. G06F 15/16

(52) U.S. Cl. 709/229

(57) ABSTRACT

An intermediary system and method are disclosed for providing users access to enterprise data via the Internet, Wireless PDA, VoIP Phone, Wireless Phone, and GSM/EDGE SmartPhone, and other communication devices. The intermediary system allows users to access enterprise data based on the user's role in the enterprise, the user's assigned privileges, or the user's object permissions. The intermediary system tailors the enterprise data for the user based on the type of communication device of the user, the point in time the user communicates with the system, or the location in a network where the user is communicating with the system. Depending on the above criteria, the user is given a “view” of the enterprise data that relates more directly to the user's current needs, duties, and tasks.

### CROSS-REFERENCE TO RELATED APPLICATIONS

This is a non-provisional of U.S. Provisional Application Ser. No. 60/647,924, filed Jan. 27, 2005, which is incorporated herein by reference and to which priority is claimed.

### FIELD OF THE INVENTION

The subject matter of the present disclosure generally relates to access of data via a custom personalized view. More particularly, the subject matter of the present disclosure relates to a system and method for accessing data via Internet, wireless PDA, SmartPhone, text to voice, and voice to text messaging.

### BACKGROUND OF THE INVENTION

The advent of wireless Internet-enabled devices, laptop computers, handheld PCs, and other mobile devices have made work environments in Sales, Marketing, Finance, Operations, Production, Inventory Control, Messaging, and other areas more mobile than ever before. Business professionals can have a traveling “view of information” for their various work related needs. Being connected anytime and anywhere to their information via mobile devices is very advantageous for business professional, but there are often situations when the business professional needs to obtain data that is difficult, if not impossible, to access using current technology. Today's business data is typically stored in central repositories, such as enterprise databases. While accessing enterprise data is relatively straightforward with a broadband connection, problems in accessing the data becomes more difficult when a broadband connection is not available, such as is often the case for the mobile professional.

Wireless networks of today may present a viable option for the mobile professional to access data; however, current wireless network access is generally very slow and unpredictable. Many PDA and wireless manufacturers offer access to the Internet with their devices. What business professionals need is the ability to access individualized data on demand practically anytime and anywhere via a wireless phone, wireless PDA, or SmartPhone. For example, the mobile professional in an enterprise may need to view information based on a location, the professional's role in the enterprise, their privileges to information, their skill set, user authentication, etc. Currently, a very limited subset of Internet sites are personalized for WAP (Wireless Application Protocol) protocol transport and data coded in WML (Wireless Markup Language) or user defined HTML (Hypertext Markup Language) code used to personalize a company's web data.

It is known in the art to access data by voice. For example, banking institutions and credit-card agencies provide access to personal banking and credit-card information by allowing a user to navigate through sets of “voice” prompts. In another example, a Director of Admissions at a Hospital may use voice prompts to verify medical insurance and voice authentication to validate approved insurance. These types of voice access to data are very limited. In particular, these voice access techniques only allow access to a very limited set of institution-generated data, and the mechanism for accessing the data is very static. For instance, under most voice-enabled access systems for bank data, an individual may access their own account data only through a predetermined fixed navigation path.

For some time, enterprises have implemented information systems that are devoid of any integrated intelligence and are defined by legacy systems designed to automate processes and transactions. Although companies may have been able to gain short-term efficiencies in operations, they are unable to gain a single, larger view of their enterprises. A need exists in the art for an information and communication system for an enterprise that integrates the disparate functions of the enterprise to ensure that everyone is doing their job based on the same information. A need also exists that allows user to access such central information in a way that is familiar and that allows for communication regardless of the software, web-enabled phone, Personal Digital Assistant (PDA), PocketPC, or other devices being used.

The subject matter of the present disclosure is directed to overcoming, or at least reducing the effects of, one or more of the problems set forth above.

### BRIEF DESCRIPTION OF THE DRAWINGS

Preferred embodiments and other aspects of subject matter of the present disclosure will be best understood with reference to a detailed description of specific embodiments, which follows, when read in conjunction with the accompanying drawings, in which:

FIG. 1A illustrates a high-level architectural view of an embodiment of an intermediary access system according to certain teachings of the present disclosure is illustrated.

FIG. 1B illustrates a process of operation for the intermediary access system of FIG. 1A in flowchart form.

FIG. 2 schematically illustrates components of an exemplary computer system suitable for implementing the intermediary access system according to the present disclosure.

FIG. 3 illustrate an embodiment of an interface of the intermediary access system for defining access and object permission privileges for various users or user groups of an exemplary enterprise.

FIG. 4 illustrates an exemplary implementation of the intermediary access system according to the present disclosure for an enterprise.

FIGS. 5A-5D, 6A-6D, and 7A-7B illustrate various interfaces for different users of the intermediary access system of FIG. 4.

FIG. 8 illustrates another exemplary implementation of the intermediary access system according to the present disclosure for an enterprise.

FIGS. 9, 10A-10B, 11A-11B, and 12A-12C illustrate various interfaces for the intermediary access system according to certain teachings of the present disclosure.

FIG. 13 illustrates exemplary wireless interfaces for a PDA or pocket PC.

FIG. 14 illustrates an exemplary interface for a wireless telephone.

FIG. 15 schematically illustrates the intermediary system of the present disclosure connected to service providers and enterprise database.

FIG. 16A illustrate an example in tabular form of call-related information 1100 sent by an EDI feed from a service provider to the disclosed intermediary system.

FIG. 16B illustrates an example of call-related information sent by an E-mail 1150 from a service provider to the disclosed intermediary system.

FIG. 17 illustrates an example of how the disclosed system can associate call-related information to a domain or “Web Part” of the disclosed intermediary system.

FIGS. 18A-18C illustrate examples of E-mail, Call, and Letter interfaces for the disclosed intermediary system.

While the disclosed systems and methods are susceptible to various modifications and alternative forms, specific embodiments thereof have been shown by way of example in the drawings and are herein described in detail. The figures and written description are not intended to limit the scope of the inventive concepts in any manner. Rather, the figures and written description are provided to illustrate the inventive concepts to a person skilled in the art by reference to particular embodiments, as required by 35 U.S.C. § 112.

### DETAILED DESCRIPTION

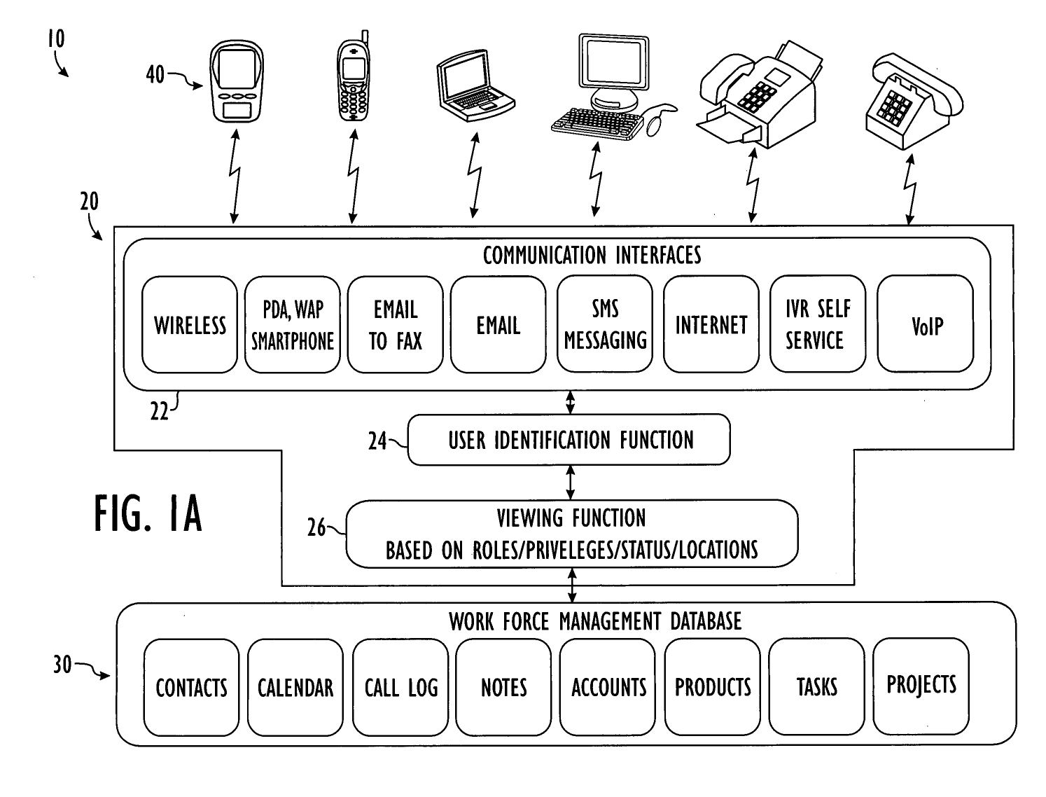

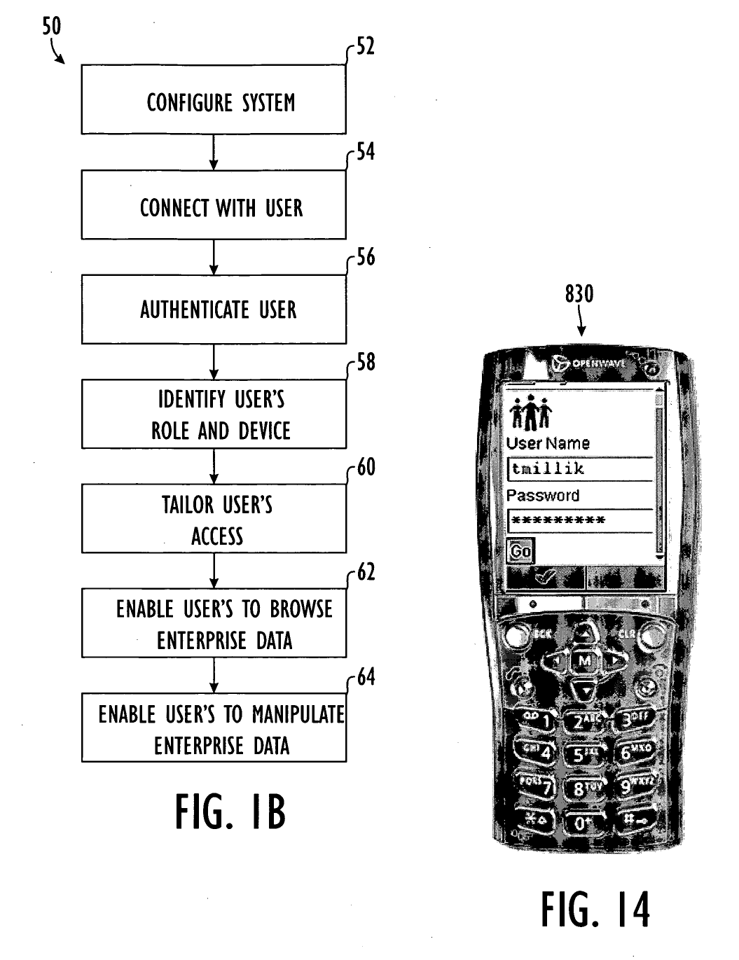

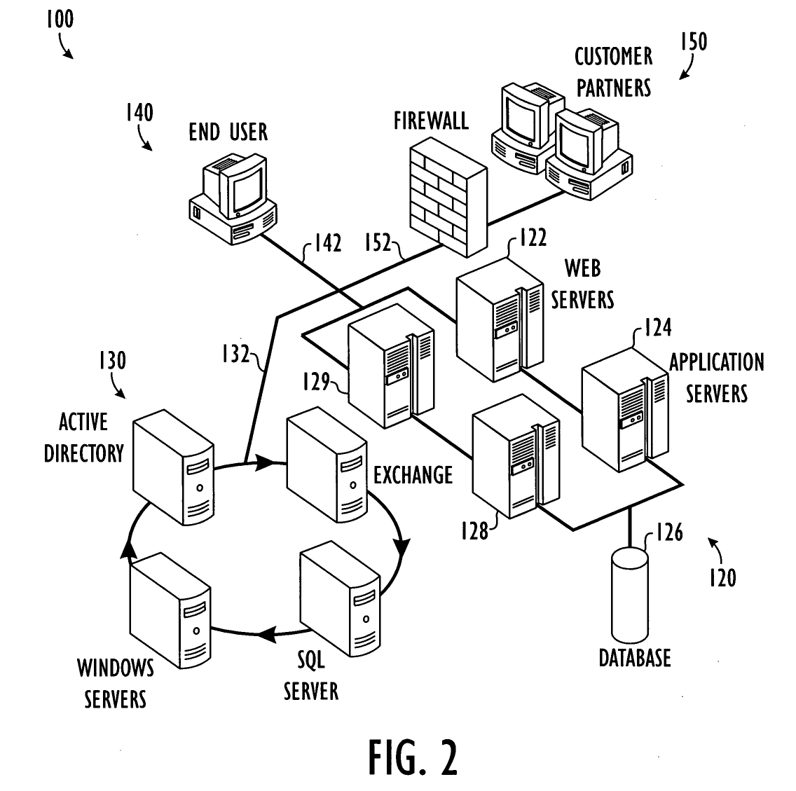

Referring to FIG. 1, an embodiment of an intermediary access system 10 according to certain teachings of the present disclosure is illustrated in a high-level architectural view. The intermediary access system 10 includes an intermediary system 20 that preferably has a multi-tiered server architecture described in more detail with reference to FIG. 2. The intermediary system 20 communicates with various communication devices or sources 40 of customers or users and provides the users access to data in an enterprise database system 30. The enterprise associated with the database system 30 can be a business, an institution, a company, a hospital, etc.

The various communication devices 40 can be based on any of the communication techniques known in the art, including web, voice, and wireless. For example, the communication devices 40 can include, but are not limited to, wireless sources (e.g., phones or devices using cellular, wireless, Global System for Mobile communications/Enhanced Data rate for GSM Evolution (GSM/EDGE), and Wireless Application Protocol (WAP)-enabled phone technologies), wireless Personal Digital Assistants (PDAs), WAP-enabled Smartphones, E-mail-to-Fax or conversely Fax-to-E-mail) sources, E-mail sources, Internet sources (e.g., computers, laptops, IP phones), Short Message Service (SMS) messaging sources, and voice sources (e.g., standard phone or Voice over Internet Protocol (VoIP) phones).

To communicate with these various communication devices 40, the intermediary system 20 includes communication interfaces 22 that have wireless, WAP, Fax-to-E-mail, E-mail-to-Fax, E-mail, GSM/EDGE, SMS Messaging, Internet, Voice-to-Text, Text-to-Voice, Interactive Voice Recognition (IVR), Voice over Internet Protocol (VoIP), Outbound Dialing, speech processing, and other capabilities.

The intermediary system 20 also communication with the enterprise database system 30. As its name alludes to, the intermediary system 20 acts as an intermediary between the users of the communication devices 40 and the database system 30. For example, the intermediary system 20 delivers data from the database system 30 to the various communication devices 40 and receives data from the communication devices 40 for delivery to the database system 30. In one embodiment, for example, a user can access and “view” enterprise data using a browser-based computer 40 connected to the intermediary system 20 by a Web site access portal as the communication interface 22. In another embodiment, for example, a user can access and “view” enterprise data using an a Wireless PDA, Smartphone, VoIP-enabled Terminal phone, or a landline phone connecting to a voice recognition portal as the communication interface 22. The voice recognition portal can enable text-to-speech and speech-to-text communication. Accordingly, a user can access or “view” enterprise data based on any of the communication techniques disclosed herein.

To allow users of the various communication devices 40 to access information in the database system 30, the intermediary system 20 includes a user identification function 24 that authenticates the user, the user's device, and the user's access privileges. When a user is identified and authenticated, the intermediary system 20 includes a viewing function 26 that tailors the “view” (i.e., access, presentation, or delivery of data in the enterprises' database system 30) for the user. For example, the user's “view” of enterprise data with the intermediary system 20 can be based on the location of the user's communication device 40, the time of the communication, the position or role of the user of the device 40 in the enterprise, or the privileges of using and manipulating data assigned to the user of the communication device 40. In one embodiment, for example, the location of the user can be determined using the GSM/EDGE network IDs of the user's device 40 using triangulation via the network. The user's access to data can also be based on other procedures and resources.

The database system 30 can include various forms of data relevant to an enterprise and its professionals, such as e-mails, calendars, contacts, notes, accounts, products, tasks, projects, messages, voice mails, and other information. The enterprise database system 30 can also include, but is not limited to, Enterprise Resource Planning (ERP) information, Finance and Operations information, Customer Relationship Management (CRM) information, Supply Chain Management (SCM) information, Knowledge Management (KM) information, and Associate Message Functions, such as messaging, threaded discussions, and calendar information. The users of the communication devices 40 for the enterprise can be professionals, salespersons, suppliers, contractors, etc. Depending on the role of the user in the enterprise and the communication device 40 being used, the intermediary system 20 allows limited or configured access to information in the enterprise database system 30 and offers tailored or personalized “views” of the accessed information.

Referring to FIG. 1B, a process 50 of operation for the disclosed intermediary access system is illustrated in flow chart form. To facilitate understanding, reference to numerals of the disclosed system 10 of FIG. 1A are concurrently provided in the discussion that follows. Initially, the enterprise configures the intermediary system 20 (Block 52). Configuration includes defining users, access privileges, preferred views of enterprise information, and other activities involved in configuring how users can access, view, and manipulate information of the enterprise database system 30. For example, the configuration is initially handled by administrators of the enterprise.

Once the intermediary system 20 is configured, users can connect with the intermediary system 20 using the communication devices 40 and interfaces 22 detailed previously (Block 54). For example, a user can be a salesperson of the enterprise who is in the field. The salesperson can use SMS Messaging, verbal commands, or WAP-enabled Smartphone to access the enterprise database system 30 using the communication interfaces 22 of the intermediary system 20.

Once the users access the intermediary system 20, the identification function 22 of the system 20 then authenticates the users (Block 56). Authentication can use any of a number of techniques known in the art. For example, the intermediary system 20 can use GSM/EDGE network unique IDs for those compatible devices 40, or the intermediary system 20 can authenticate users by using IDs and passwords, log-ins, certificates, etc.

Once the users are authenticated, the viewing function 24 of the intermediary system 20 identifies the type of access available to the users. The access of a given user is defined by access criteria for that user. The access criteria define what data the user can access and how the user can view and manipulate that data. The access criteria can include one or more of a role of the user in the enterprise, the privileges assigned to the user, the status of the user in the enterprise, a location of the user in a network, or a time the user is accessing the system 20 (Block 58).

When the user's access is identified, the intermediary system 20 tailors the user's “view” of enterprise data accordingly (Block 60). Tailoring the user's “view” can be based in part on the user's current needs, duties, and tasks, as defined in the system 20. For example, the user may be able to access the enterprise data via a personalized view of the data tailored to user's role in the enterprise, the user's privileges, the user's object permissions, the point in time the user communicates with the system 20, or the location of the user when communicating with the system 20. The user's “view” can also be tailored for the particular communication device 40 being used by the user to access the data. For example, the user's “view” may use text-to-voice or voice-to-text during an interactive voice session for a user accessing the data with VoIP or standard phone. The user's “view” may also involve various web parts for accessing information via the Internet, a wireless telephone, or WAP-enabled SmartPhone or PDA.

Depending on the user's privileges, the user can be allowed to “browse” data in the enterprise database system (Block 62) and can be allowed to “manipulate” information in the enterprise database system 40 if the user's privileges allow (Block 64). In generally, the user is allowed to navigate to various domains in the user's authorize view, wherein each domain provides user interface options pertaining to a corresponding logical partition of enterprise data. For example, in an exemplary enterprise database system 40, the enterprise data may divided into domains that include Cases, Referrals, Inquiries, Cases, Opportunities, Contacts, Accounts, Calendar, Solutions (Knowledge Management), Products and user/employees domain. In accordance with the teaching and principles of the present disclosure, other domains may be added or substituted to correspond to various types of data commonly found in enterprise database systems.

The user can “browse” each domain by authentication via the user's GSM/EDGE unique ID, SMS Messaging, e-Mail header, Internet browser, or voice navigation commands speaking appropriate voice commands, which are context sensitive to the current location of the user in the domain. With Internet enabled “views” available in real time for navigation, a user can “click” to another domain to retrieve data from that domain. Users may also interactively initiate orders, view payments, access messages linked to payments, review SMS event-based messaging campaigns, track a phone call, fax a document, send an e-mail, and SMS message to selected contacts within a GSM/EDGE identified area/venue/stadium/hospital, account, and/or employee through the intermediary system while participating in a user session.

As evidenced by the process discussed above, the intermediary system 20 offers users (and especially mobile users) a personalized “view” of enterprise information directed to the user's particular needs for the enterprise. The intermediary system 20 can be personalized based on a number of user-specific criteria, the location or time the user accesses the information, and/or the device used to access the data. Therefore, the users accessing the enterprise information are not overloaded with data. The users only view the information they need to the task at hand or their particular role in the enterprise.

As also evidenced by the process discussed above, the intermediary system 20 can be used to automate various processes of the enterprise, such as coordinating tasks, scheduling field services, unifying contact and calendar entries, tracking and logging internal messaging, providing unified views of accounts, cases, or problems so an enterprise can begin to relate where its customers come from, to information such as average sale, time of day, distance traveled, and frequency of visits, etc.

In one example, the salesperson in the field having the WAP-enabled Smartphone may be able to view and update his/her calendar entries, contacts, accounts, and other information using the WAP browser of his/her Smartphone. The enterprise data of the user's calendar entries, contacts, accounts, etc. is tailored for delivery to the WAP pages compatible for the user's Smartphone.

In another example, a salesperson in the fields can uses a conventional phone to access the intermediary system 20, and a voice user interface (Interactive Voice Recognition application) of the communication interface 22 enables the salesperson to navigate to information stored in the enterprise database system 40 and to retrieve that information using SMS Messages and/or voice commands. Recognition of the SMS Messages and voice commands by the interface 22 can be enabled, in part, by grammar definitions that are accessed by speech recognition software operating on a server. In this example, the software “converts” the voice commands and SMS Messages into commands for navigating and requesting data that is then returned to the software in an application-readable (e.g., text) form. In turn, the software processes the data request commands to navigate the user to a new location or retrieve requested data.

Depending on the domain pertaining to a user's data request, data may be retrieved from a voice database or retrieved from the enterprise database system 40 via an enterprise database system API (application program interface) that enables the speech recognition software to access the enterprise database system 40. In one embodiment, the enterprise database system 40 includes an enterprise server that provides access to the enterprise database through an object and permissions layer, a roles and privileges layer, and a data layer.

With the benefit of the high-level architecture of the disclosed intermediary access system of FIG. 1A and its process of operation in FIG. 1B, we now turn to an exemplary computer system 100 suitable for implementing the disclosed intermediary access system. In FIG. 2, components of the computer system 100 are schematically illustrated. The computer system 100 includes an intermediary server system 120 and a data server system 130. End users 140 and customer/partners systems 150 can communicatively connect to the computer system 100.

The intermediary server system 120 has a multi-tiered system server architecture, which includes Web servers 122, Application servers 124, a core database 126, a voice server 128, and various other servers 129. The data server system 130 is an enterprise database system storing enterprise data or is an internet hosting service storing enterprise data. The data server system 130 can include exchange servers, active directories, SQL servers, Windows® 2000/2003 servers, and Windows® NT servers, for example. The data server system 130 has a communication path 132 with the intermediary server system 80. For example, the communication path 132 can include one or more Enterprise Data Import (EDI) feeds for migrating data from various sources of the database system 130 to the intermediary server system 120.

The end users 140 include all of the various devices and communication sources 140 discussed above with reference to FIG. 1. The end users 140 connects with the intermediary server system 120 via a communication path 142, which as noted above can include web-based, voice-based and wireless-based (i.e., WAP) communication paths. The customer/partners system 150 is connected to the intermediary server system 120 via a communication path 152, which can be a standard internet connection separated by a firewall.

The intermediary server system 120 communicates with the data server system 130, the end users 140, and the customer/partners system 150. The intermediary server system 120 has defined access information, which allows the end users to access information based on the user's role in the enterprise, the user's privileges to access information, the user's location in a GSM/EDGE network. The defined access information is entered using a “Set Up” manager, such as discussed below with reference to FIG. 3.

To communicate with mobile devices of the end users 140, the intermediary server system 120 is coupled to a mobile data communication system (not shown). To communicate with internet devices of the end users 140, the intermediary server system 120 is internet-based and is coupled to application specific remote data sources over a communication path 82, such as the Internet or Public Switched Telephone Network (PSTN). The intermediary server system 120 also includes interface software (not shown) for extracting data from application specific remote data sources 130 and generalizing the extracted data by constructing core data objects. The intermediary server system 120 also includes software (not shown) for presenting the generalized data to end users 140 (e.g., mobile devices and sources). This generalized data includes “web parts,” which are described in more detail below with reference to FIGS. 9 through 29C. In turn, the communication sources 140 of the end users 140 include web browsers and application templates for displaying data from the intermediary server system 120 and entering data to be sent to the server system 120.

Data flow is two way between communication paths 132 and 142 of the data server system 130 (e.g., enterprise applications, ASP applications) and communication sources 140 (e.g., phone, fax, e-mail, mobile devices, etc.) with the intermediary server system 120. All the data communicated between integrated applications (enterprise applications and ASP applications) and mobile devices 140 pass through and are directed by the intermediary server system 120. Accordingly, the system 120 is able to communicate over a variety of communication paths (including Web, WAP, and Voice) to various personal devices and desktop internet browsers of the end users 140 using a number of protocols. For example, an HTML communication source 140 enables web browser interfaces. A Voice style communication source 140 enables telephone interfaces with speech recognition and text-to-speech synthesis. An Handheld Device Markup Language or Wireless Markup Language (HDML or WML) communication source 140 delivers content to wireless digital telephones through a WAP gateway and network. An Extensible Markup Language (XML) adapter works over Hypertext Transfer Protocol (HTTP), enables server-to-server integration with ASP applications and provides functionality, such as synchronization with desktop personal information management applications (e.g., Microsoft Outlook) and PDAs.

Focusing on the intermediary server system 120, the web server 122 is configured to communicate with web devices and wireless WAP-enabled devices 140 via the Internet as communication path 122. The server 122 responds with HTML (for web users), WML (for WAP users), and XML or server-to-server communications with third parties 150. WAP requests come through a WAP gateway or a wireless ISP (not shown). For voice communication with the data, the intermediary server system 120 has a voice server 128, which is described in more detail at the end of the present disclosure.

The computer system 100 of FIG. 2 can provide for secure access to enterprise data. The intermediary server system 120 interfaces to enterprise data sources on database system 130 (for public services) or on customer/partner system 150 (for private services) through secure Virtual Private Networks (VPN). All enterprise data remains with the enterprise where it can be secure. In a preferred embodiment, the intermediary server system 120 conforms to industry standards on authentication and encryption at the Secure Socket Layer (SSL), using VeriSign technology and also at the WAP Gateway level with Wireless Transport Layer Security (WTLS). Each end user 140 (whether using a mobile device or not) is preferably required to login to the intermediary server system 120 with a unique user-ID and password. Using SSL/WTLS can ensure that any information exchanges with intermediary server system 120, during a session, can be secure.

At the application level, for example, the end users or devices 140 can access the intermediary server system 120 by supplying a username/password for web-based devices 140; an account number and PIN for wireless devices 140, voice print authentication (with backup of account number and PIN) via voice recognition for voice devices 140 or via fingerprint authentication for Tablet PCs 140. Once logged in, multiple end users can be given permission to have authoring privileges over subsets of data from the database system 130. For example, both the end user and the enterprise that the end user works for can make changes to the end users work address. These changes are then propagated to another part of the enterprise (e.g., a project team).

The intermediary server system 120 preferably requires a single sign-on between integrated applications accessed via intermediary server system 120. This means once an end user has logged in, they do not have to repeat their username and password to access individual areas of an application functionality. Thus, in addition to providing unified application access, the intermediary server system 120 preferably provides a unified login procedure.

At the data level, for example, the intermediary server system 120 has a Distributed Data Storage (DDS) architecture. The DDS architecture can implicitly provide for data security. This means that while providing system to one enterprise, on an ASP basis, that enterprise's data store of database system is kept independent and secure from other enterprises.

The intermediary server system 120 and database system 130 can be implemented in two ways. In one example, the enterprise hosts the application and data of the database system 130 at their own secure local site, which is linked to intermediary server system 120. This may be the typical configuration for large enterprises, which may already have an extensive database system 130 and the ability to manage it. In another example, the database system 130 for the enterprise is hosted on a distributed database at a secure data center, and intermediary server system 120 interfaces to the enterprise data through a firewall and Virtual Private Network (VPN). This may be the typical configuration for small to medium enterprises.

The intermediary server system 120 acts as an intermediary between the enterprise data stored on data server system 130 or customer system 150 and the end users 140 having the various communication sources 140. The intermediary server system 120 maintains a subset of profile information (when authorized) on the end users. Optionally, the intermediary server system 120 maintains private directory information in a distributed database on a system-hosted server. At the lowest level, a system administrator of the enterprise has full control of data and end user privileges for the enterprise. At other levels, individual end users can customize and control data and/or their user privileges.

Acting as an intermediary, the intermediary server system 120 communicates data from remote stores of the enterprise database system 130 to the communication source 140 (e.g., mobile devices having web browsers) of an end user 140. To communicate the data, the intermediary server system 120 extracts data objects from the data stores of the database system 130 and processes the extracted data with the servers 122, 124, etc. of the server system 120. When processing the data, the server system 120 generalizes the extracted data objects based upon application specific rules and criteria. Then, the server system 120 presents the normalized data objects to the communication source 140 (e.g., the web browser of the mobile device) based upon specific rules of the source.

Acting as an intermediary, the intermediary server system 120 preferably allows for seamless integration between enterprise data on database system 130 and a variety of mobile and remote applications of end users 140. For example, the intermediary server system 120 can be used to integrate order entry, shipping verification, case tracking, address books, email, calendars, directory services, and document tracking between a remote end user 140 and the database system 130. Rather than having to switch from application to application on a mobile device 140, an end user is able to use the intermediary server system 120 as a data point available from a data set in one application to access a set of data in another application. Access is based on user specific criteria, such as a defined role of the end user in an enterprise, defined object permissions of the end user in the enterprise, status of a customer in the end user's enterprise, the location of the end user, the time of the end user's communication, and etc., which are all discussed in more detail below.

Thus, in one embodiment, an end user 140 may have a mobile communication device 140 (e.g., a PDA enabled with WAP). The user logs on to the intermediary server system 120 via their PDA 140 and wireless communication path 142. Based on the user's log on, the intermediary system 120 allows the user to access enterprise data from the database system 130 and/or the database 128. The user may be allowed to access only certain enterprise data based on one or more of the following criteria: the user's role in the enterprise, the user's privileges or object permissions to access information, the time the user is accessing information, and the location of the user when accessing the information.

The intermediary system 120 either stores the enterprise data on location (e.g., in database 126) or obtains the data via link 132. Having the data, the intermediary system 120 presents the data to the user's PDA 140. The presentation of the data can be personalized by the user and can be tailored for the particular communication device 140 being used by the user. As noted above, the communication path 142 can involve connection through the Internet and wireless communication service.

As noted above, the intermediary server system 120 can limit or tailor the delivery of enterprise data to end users based on the user's location, time of the communication, the user's role in the enterprise, the user's profile, and various other procedures. Because the intermediary server system 120 is capable of communication with mobile users, the system 120 preferably incorporates capabilities of location awareness services (e.g., GSM/EDGE, Geographic Information System (GIS)), outbound messaging, alerts and notifications, e-mail, and calendaring plug-ins. These capabilities are incorporated into the platform of the system 120 using XML or other standard interfaces, such as LDAP, IMAP4, POP3, CDO, SQL, and SMTP.

For example, the intermediary server system 120 can have the capability of determining what a user can access and view of the enterprise information based on that users location provided by a GSM/EDGE network ID or Geographic Information System (GIS), for example. If a user with a mobile device is in a product shipping area of an enterprise, for example, that user may only be allowed to access information pertaining to shipping while located in that area of the GSM/EDGE and/or GIS network.

In another example, the intermediary server system 120 can have the capability of producing Message Alerts. The message alerts can be sent to users from the intermediary server system 120 to selected users. For example, mobile field technicians, sales persons, and service personnel away from their desktop “view” of enterprise data can receive alert messages and can access their Calendar, Contacts, and Tasks when traveling. In another example, if the enterprise using the intermediary server system 120 is a dating service, members of the dating service who are traveling may receive a notification that a particular profile of another member is located near them. In this way, the location of the member when traveling—where the location is based on GSM/EDGE network or Geographic Information System (GIS)—can be used to coordinate a message alert to contact other members.

As alluded to previously, an end user 140 may have a conventional cell phone or a landline phone but may still access the intermediary server system 120 and review information using interactive voice recognition (IVR) techniques. Therefore, the intermediary server system 120 can use IVR techniques known in the art to allow an end user 140 to use speech to “navigate” through the “web parts” and “interfaces” of the user's personalized “views” of the enterprise data on database system 130 and to communication enterprise data to the user 140. Some IVR techniques known in the art use “dialogic” to process speech.

In one embodiment, the intermediary server system 120 of FIG. 2 can have the voice server 128, which uses commercial voice services through an NMS card (not shown) and a speech Application Program Interface (API) (not shown). The voice server 128 uses the same application services (both internal and third party) via an application layer as the Web and WAP-enabled devices 140 to access address book, calendars, location service GSM/EDGE network IDs and/or Geographic Information System (GIS). Voice access to these services is through well-defined Remote Method Invocation (RMI) interfaces (not shown). The voice server 128 includes voice applications, a voice recognition client/call recording, which includes a telephony interface.

The voice server 128 may use various additional servers 129 for processing speech. For example, the additional servers 129 may include a speech processing server, a text-to-speech server, a voice recognition server, a grammar update utility, a compilation server. The voice server 128 uses the compilation server 129 (through speech API) to compile dynamic grammars from a grammar and voice print database of core database 126 for various tasks, such as when a user updates their address book from the Web. The voice server 128 also communicates with the compilation server 129 and a recognition server 129 and Text-To-Speech and Speech-To-Text using speech API and e-Mail to Fax, Fax to e-mail using speech API.

The voice server 128 and other servers 129 enable users of a voice communication device 140, such as a wireless phone, landline phone, or VoIP device, to access stored data using SMS Messaging, verbal commands, and GSM/EDGE network unique IDs. Wireless phones access the intermediary server system 120 via a wireless service provider and a phone bank exchange (PBX) (not shown). Similarly, landline phones access the intermediary server system 120 via a landline phone network and PBX. The voice server 128 can be connected with one or more PBX's via a T1 connection or greater. SMS Messaging, web self-service, and voice server 128 are linked to a speech-processing server 129 and to a data server system 129, which provides access to the enterprise database.

Information in the enterprise database system 150 or stored locally in database 126 that can be accessed by IVR techniques can include, but may not be limited to, opportunities data, admissions data, referrals data, insurance verification, document data, Solutions/KM data, contacts data, accounts data, calendar data, employee data, as well as other types of enterprise data. The speech server 128 provides speech processing and understanding, modifies the user's verbal request into data the voice applications utilize to retrieve the requested information from the enterprise database. This information is sent back via the SMS Messaging or interactive voice recognition (IVR) techniques to speech processing server 129, which converts the data into a voice format.

To facilitate the IVR techniques, the intermediary server system 120 can use the unique GSM/EDGE network IDs and/or Geographic Information System (GIS) from the communication device 140 of the end user to determine what enterprise data to offer to the user during an IVR session. For example, an end user can access the intermediary server system 120 with their wireless telephone 140 from a job site. Based on the GSM network ID or GIS provided during the communication with the wireless telephone 140, the intermediary server system 120 may offer the end user limited or tailored access to orders related to the job site at the location, contacts related to the job site, tasks related to the job site, etc. In addition, based on the time and date that the end user connects to the intermediary server system 120 using IVR techniques, the system 120 may offer the end user limited or tailored access to calendar entries, appointments, and task related to that time. Being able to reduce the amount of information offered to the end user during IVR sessions enables the intermediary server system 120 to provide information that is more relevant to the end user when and where the end user needs the information in the field. In addition, by limiting or tailoring access to information, the intermediary server system 120 eliminates the need for the end user to “navigate” through a plurality of menu selections to find the information eventually that the user needs.

In another embodiment of the intermediary server system 120, speech recognition techniques available on a Microsoft Tablet PC input panel (such as version 1.7) can be used, which gives the Tablet PC some internal speech-recognition capabilities. The speech recognition on Tablet PCs can allow an end user to use his voice instead of a mouse, keyboard, or pen to control Microsoft Windows-based programs on the Tablet PC. The end user can also use their voice to dictate text. Therefore, an end user can use the speech recognition capabilities of a TabletPC 140 to access the intermediary server system 120 and to navigate the user's personalized view of enterprise data. The Tablet PC or other device 140 having this speech recognition capabilities can thereby process the speech from the end user and can only send queries to the intermediary server system 120 for processing. Thus, this embodiment may avoid the need to use the speech processing servers 128 and applications of the intermediary server system 120.

As evidenced by the above discussion, the intermediary server system 120 of FIG. 2 can reduce problems associated with providing information to end users of an enterprise. Typically, end users (e.g., mobile professionals, field technicians, etc.) in an enterprise are given or have access to more information than what they need given their role in the enterprise or what their current task in the field may be. The intermediary server system 20 can also reduce problems associated with providing access to vital information for end users (e.g., mobile professionals, field technicians, etc.) within the enterprise by providing unified personalized access based on end user profiles.

To discuss how information and access can be personalized for end users, we turn to FIG. 3. An interface 200 of the intermediary server system of FIG. 2 is illustrated. This interfaces 200 can be used to define access and object permission privileges for various end users or user groups 202 of an exemplary enterprise. Using the interface 200, for example, a system administrator or other user of the enterprise can set up fields and related information for the various interfaces of the disclosed system. The interface 200 includes a plurality of set up items 201, which allow system administrator to configure and tailor the disclosed system to their enterprise. In the present example, the set up items 201 are directed to a sales oriented enterprise and include such items as audit tables, companies, competitors, custom fields, default values, departments, fields, locations, lookup items, partners, positions, sales teams, supplies, support teams, templates, user groups, and users. It will be appreciated that the various setup items can be tailored to suit any enterprise, such as a hospital, sales company, spa/salon, dating service, etc.

From the set up item 201 entitled “User Groups” or “Users,” the system administrator can define object permissions (e.g., under object permissions tab 204) for various users 202 of the enterprise. The objects 206 relate to aspects of the enterprise, such as billing, contacts, customers, etc. The permissions 208 define what the selected user or user group 202 can do with the given object, such as view, access, add, delete, etc. Under a customer status tab 205, access privileges and object permission for the user group or user can be defined as it relates to customers, who are active, inactive, prospective, and etc.

By way of example, FIG. 4 illustrates an exemplary implementation 300 of an intermediary access system 360 according to the present disclosure for an enterprise. A hospital emergency room is an example of an enterprise where a number of personnel have different functions and responsibilities. Due to the disparate nature of the personnel's duties in a hospital, each person as a user of the hospital's database system 370 requires access to different amounts and levels of information at the hospital. The personnel can include an ER admissions clerk 310, a triage nurse 320, doctors and technicians 330, admissions personnel 340, and administrators or supervisors 350, for example. Each of these users requires different access to the database system based on roles, privileges, and corporate compliance (i.e., HIPAA for Healthcare) 370.

As evidenced herein, the intermediary access system 360 of the present disclosure allows the users 310, 320, 330, 340, and 350 to access the enterprise data 370 via various communication devices, such as wireless phones, desktop workstations, PDAs, Tablet PCs, laptops, etc. The access of the each user 310, 320, 330, 340, and 350 can be personalized based on the users' roles, privileges, object permissions, or location in the hospital. In this way, each user 310, 320, 330, 340, and 350 can see and manipulate only the information they need to for their task at hand. Although not shown in FIG. 4, it is understood that a number of various communication links interconnect the intermediary access system 360, database system 370, and users' communication devices 312, 322, 332, 342, 344, and 352.

For example, a patient 302 arriving at the emergency room typically checks in with the ER admissions clerk 310, who takes basic information about the patient, such as name, address, injury, insurance provider, etc. The admissions clerk 310 is typically at a desk and has a desktop workstation 312 for entering information. When checking in at ER admissions, the patient's information is entered into the computer system 370 via the intermediary access system 360, and a patient ID may be assigned to the patient 302.

The patient 302 may then be seen by the triage nurse 310, who takes vital signs and other basic history from the patient 302. This nurse may have a mobile device 322, such as a wireless PDA or Tablet PC, on which to enter information. The triage nurse 320 does not need to access much of the information already entered on the patient 302 and may only need to input data related to weight, pulse, blood pressure, allergies, etc.

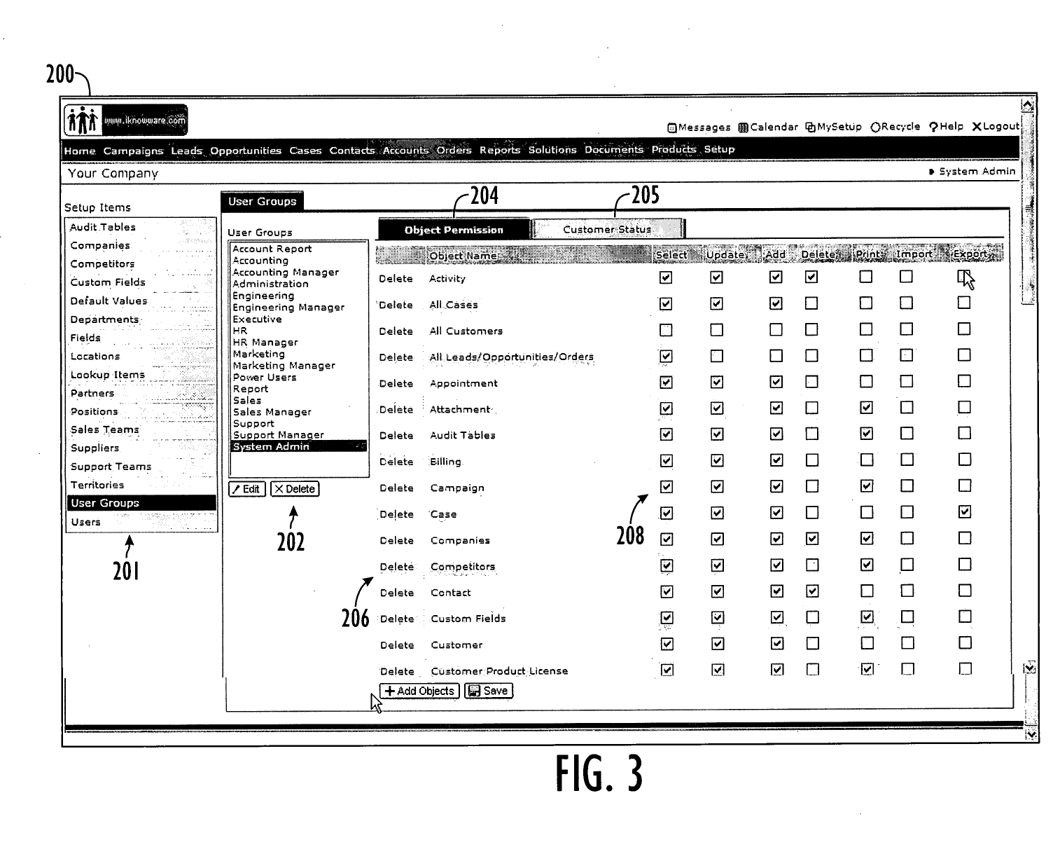

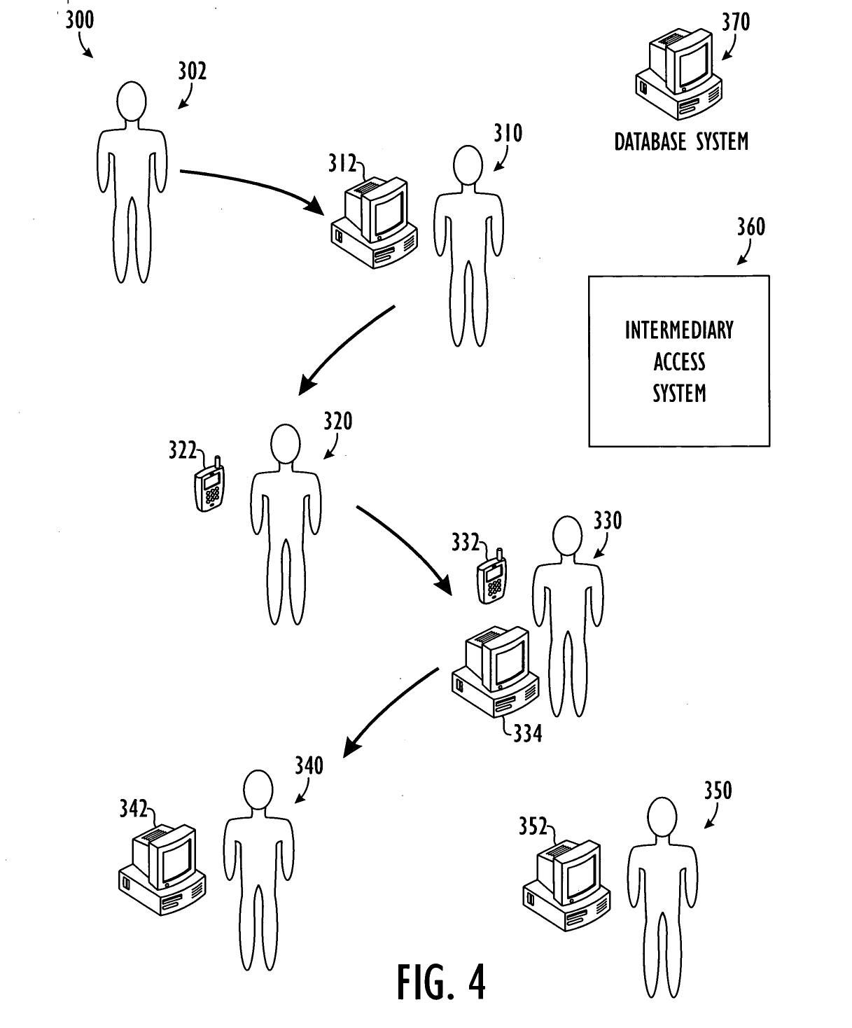

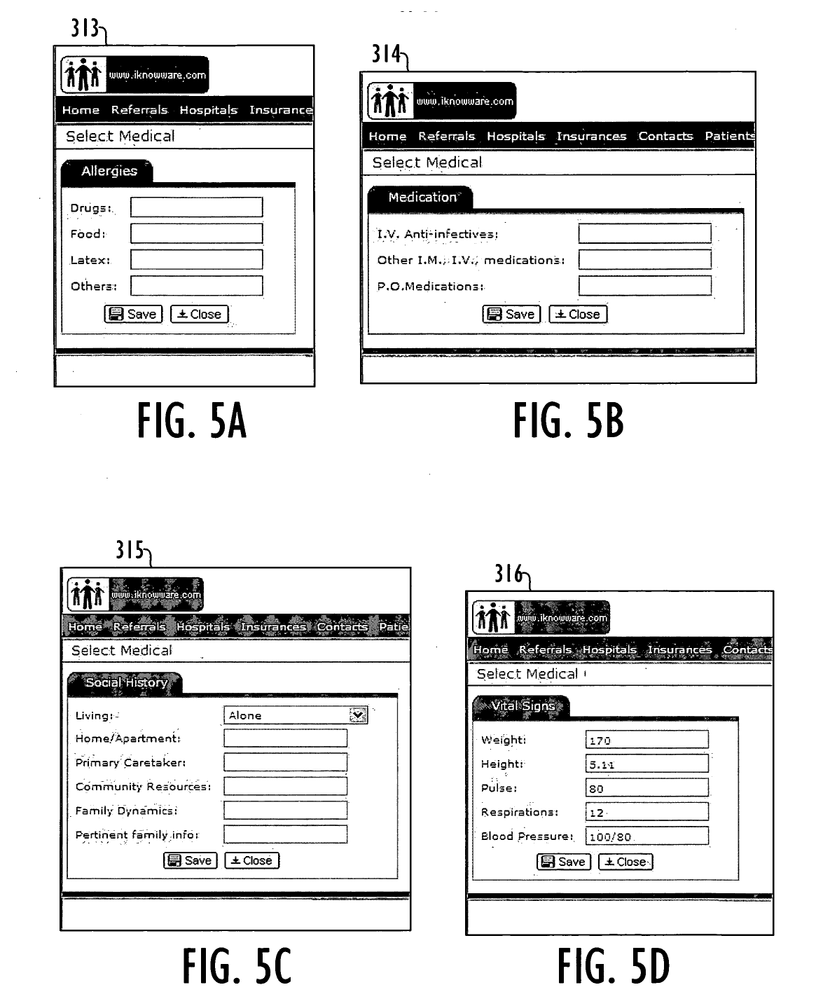

FIGS. 5A-5D illustrate exemplary user interfaces 313, 314, 315, and 316 for triage nurses to access when performing their duties. These exemplary user interfaces 313, 314, 315, and 316 are implemented by the intermediary access system 360 of the present disclosure. In one embodiment, the information and views of enterprise data that the triage nurse can view, access, and enter for the patient may be based on her defined role in the hospital (i.e., triage nurse) and/or the privileges and object permissions assigned to the nurse. In another embodiment, the information and views of enterprise data that the triage nurse can view, access, and enter for the patient may be based on the location of the nurse 320 with device 322 in a GSM/EDGE network and the GSM/EDGE network ID of her device 322.

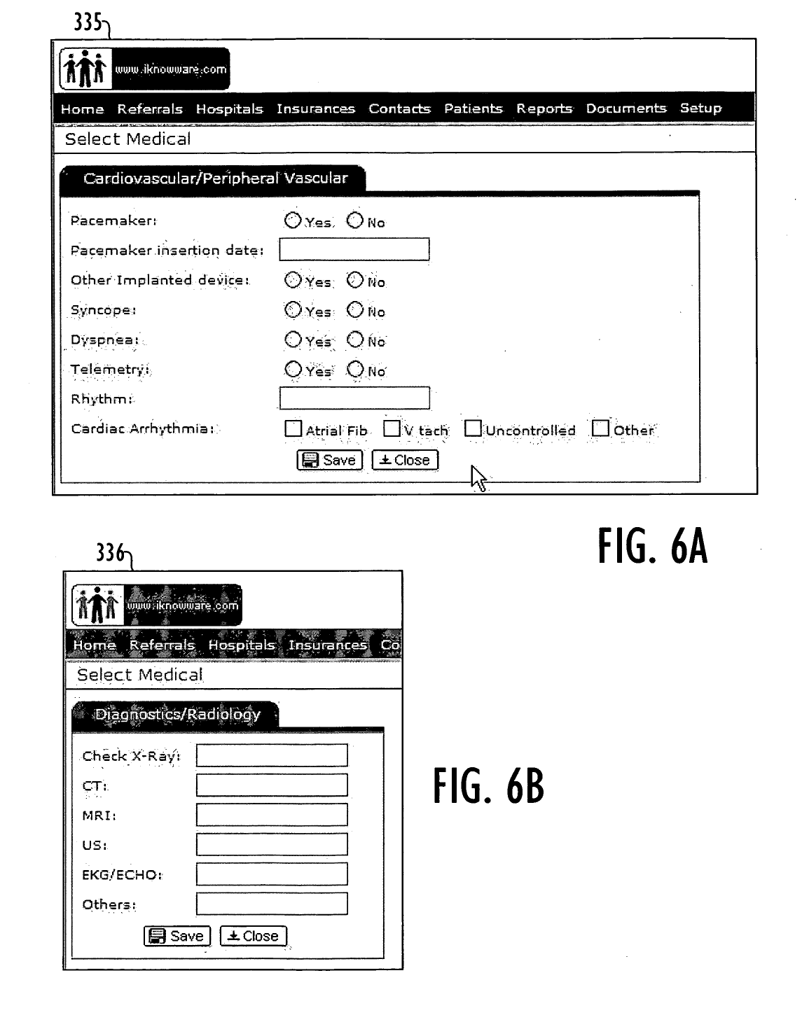

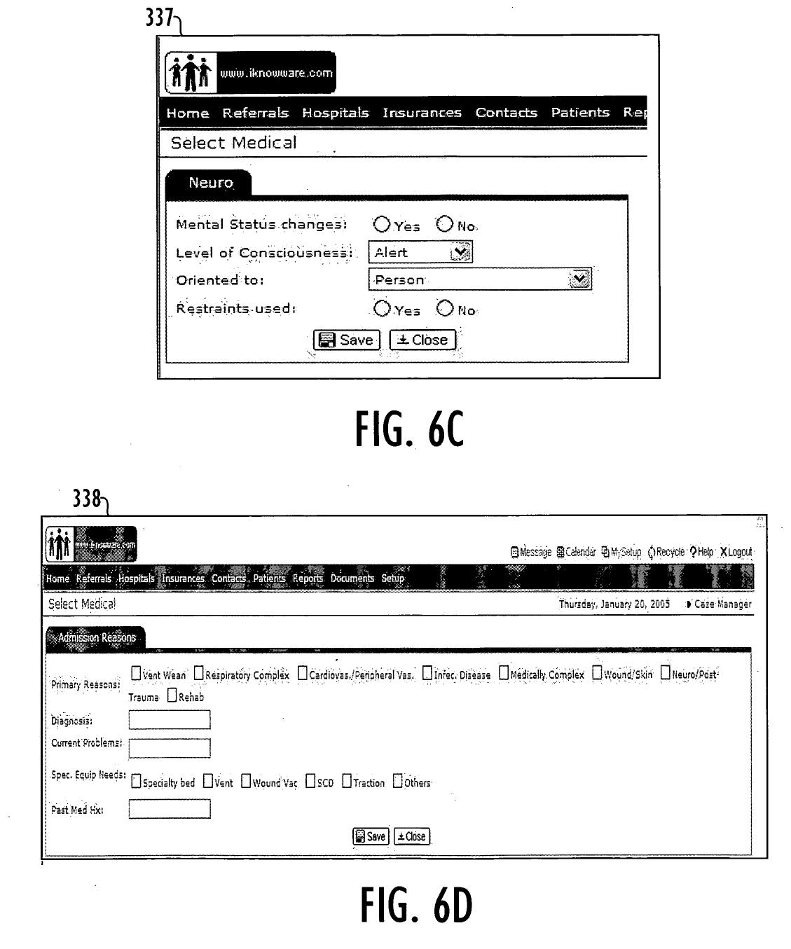

The patient 302 may then be seen by a number of doctors or technicians 330, who may use various devices 330, 332 to input and access information on the patient 302. For example, the doctors 330 may have a wireless PDA or Tablet PC 332 or a workstation 334 for inputting information. Again, the doctors 330 do not need to access all of the information on the patient so that their user privileges may be defined differently than those of the ER admissions clerk or triage nurse. FIGS. 6A-6D illustrate exemplary user interfaces 335, 336, 337, and 338 for doctors to access when performing their duties.

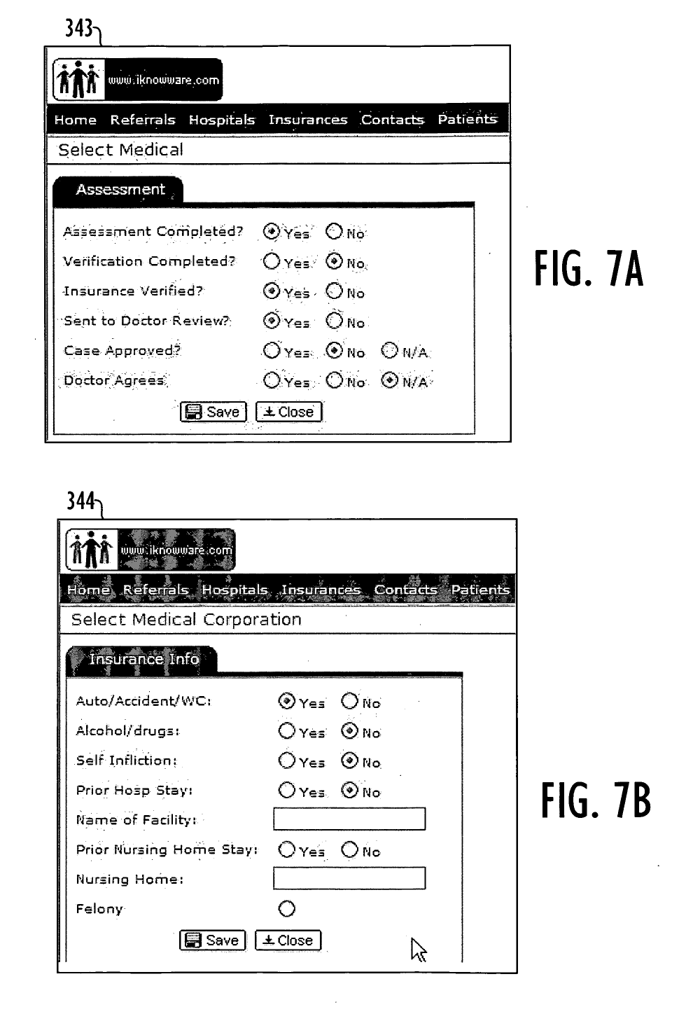

When the patient 302 is admitted, hospital admissions personnel 340 may access and enter information on the patient 302 using a communication device 342. Again, admission personnel do not need to access all of the information on the patient 302. FIGS. 7A-7B illustrate exemplary user interfaces 343 and 344 for admissions personnel to access when performing their duties. As shown in FIG. 4, a hospital administrator 350 may have privileges to access all of the information entered by the admissions clerk 310, triage nurse 320, doctors 330, and admissions personnel 340. However, based on log-on IDs, certificates from the communication devices, or other forms of authentication and depending on the object permissions defined for each user, the various users 310, 320, 330, 340, and 350 may or may not be allowed to view, change, or edit the information entered by other users or stored in the intermediary system 360 or computer system 370.

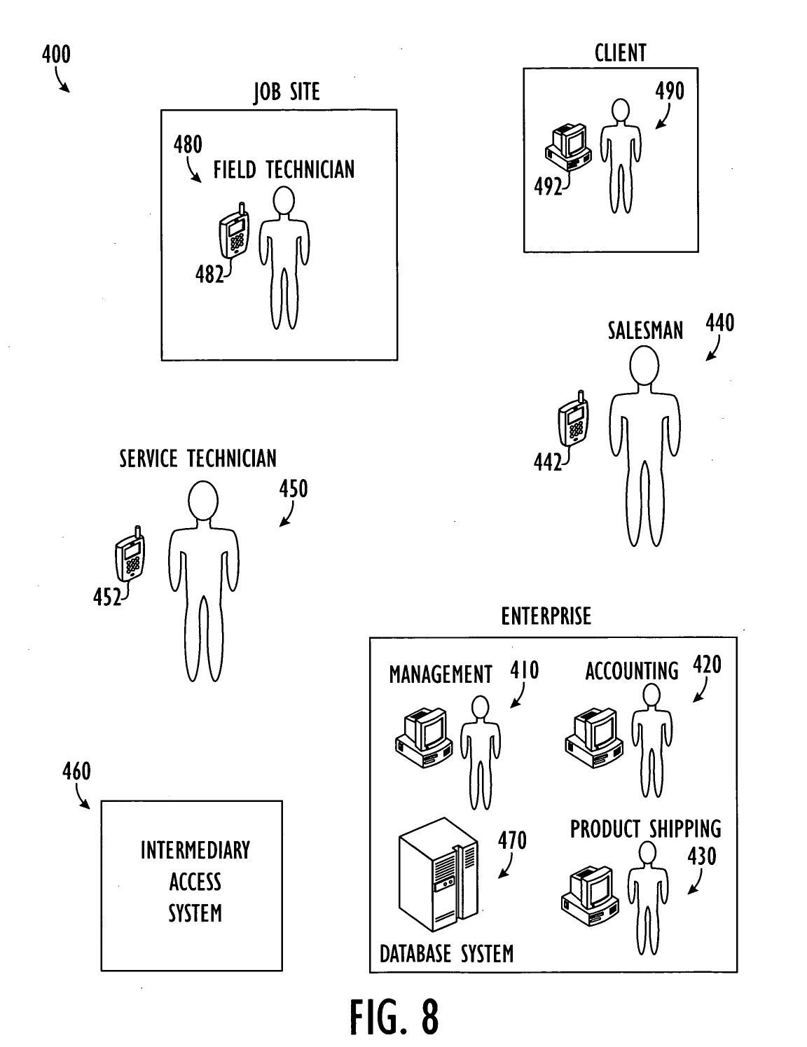

By way of another example, FIG. 8 illustrates another enterprise suitable for implementing an intermediary access system 460 according to the present disclosure. A business is an example of an enterprise where a number of personnel may be involved in different aspects of the business. For example, there may be management 410, accounting 420, product shipping 430, salespersons 440, service technicians 450, field technicians 480, and clients 490, just to name a few of the parties involved in the business. Each of these parties requires different access to information from the enterprise database system 470. For example, salespersons 440 may require access to and the ability to log and update accounts, conferences, leads, contacts, etc. Management 410 may require access to all levels of information. Product shipping personnel 430 may require access only to product inventory and accounts. Service technician 450 may require access to product information, orders, and contacts. Moreover, Clients 490 require an entirely different form of restricted access to information than given to the members of the business. Because many of the parties, such as salespersons 440 and technicians 450 and 480, are relatively mobile and away from the business, they will typically have mobile devices 442, 452, and 482 (e.g., wireless phones, PDAs, Tablet PCs, laptops) and will need to access enterprise database system 470 remotely.

As evidenced herein, the intermediary access system 460 of the present disclosure allows the users 410, 420, 430, 440, 450, 480, and 490 to access the enterprise database system 470 via various communication devices, such as wireless phones, desktop workstations, PDAs, Tablet PCs, laptops, etc. The access of the each user 410, 420, 430, 440, 450, 480, and 490 can be personalized based on each user's role, privilege, object permission, or physical location. In this way, each user 410, 420, 430, 440, 450, 480, and 490 can see and manipulate only the information they need to for their task at hand. Although not shown in FIG. 8, it is understood that a number of various communication links interconnect the intermediary access system 460, database system 470, and users' communication devices 442, 452, 482, 492, etc.

In this example, salespersons 440 may use their wireless devices 442 to access and update contacts, calendar, orders, and client accounts while traveling. Field technicians 480 at a job site may request a part or product with mobile devices 482, and service technicians 450 with the skills to install the part and located near the job site may be dispatched to the site to install the part. In this regard, the intermediary access system 460 can be used by the users to communicate with each other via messaging, e-mail, call logs, etc. The intermediary access system 460 can store skill levels of the service technicians and can determine their location based on GSM/EDGE identification so that the appropriate technician can be dispatched to the jobsite for the task at hand. These and other benefits provided by the intermediary access system 460 will be apparent to one skilled in the art with the benefit of the present disclosure.

In addition to defining access and object permissions of end users and communicating with the user's various communication devices, the disclosed intermediary access system 460 allows end users to access and personalize contextual information using voice devices, wireless devices, and Web devices. This personalized, contextual information is obtained from application interfaces with enterprise, personal, and public data stored at the enterprise database system 470 and/or at the intermediary access system 460. The user can create personalized interfaces with existing enterprise applications, such as Microsoft Outlook and Lotus Notes; personal applications such as contact managers, e-mail to Fax/Fax to e-mail applications, mapping application, and communication service application, such as e-mail, voice activated ordering, notifications and alerts. A personalized user profile determines business workflow and delivers relevant information via the communication devices used by specific user interfaces for voice, wireless and the Web. This approach provides significant ease of use and productivity benefits to the users.

Referring to FIGS. 9, an exemplary interface is illustrated for end users to personalize information of enterprise, personal, and public data stored at an enterprise system and/or at an intermediary server system according to the present disclosure. In FIG. 9, for example, a home web interface 500 shows a plurality of interfaces or “Web Parts” 510 and depicts some generic objects of “Web Parts” for calendar 520, notes 530, and system log-ons 540.

Although not depicted in FIG. 9, the interface 500 can provide access to objects or “Web Parts” for all types of application data, including e-mail, directory services, and the like. For example, the home interface 500 can include various “Web Parts” directed to various domains. Just as an example, the interface 500 can include “Web Parts” directed to domains, such as a log-in domain, an opportunities domain, a case domain, a solutions/document domain, a referral domain, a admission domain, a inquiry domain, a contacts domain, and accounts domain, a calendar domain, products domain, and an employee domain. After logging into the disclosed system via log-in domain, the user enters one of the remaining five domains: Cases, Leads, Referrals, Admissions, Inquiries, Solutions/KM, Products, Opportunities, Contacts, Accounts, Calendar, or Employees. From those domains, the user can make a query to access various data fields corresponding to the domain the user is currently in.

In the home interface 500 of FIG. 9, each of the core objects or “Web Parts,” such as new messages, tasks, unassigned cases, my cases, shipping orders, unassigned leads, etc, can be displayed and are listed on menu 502. For a particular user to even view a web part 510, the user must be provided with the object permission to view the web part 510. For example, a salesman may have access to view information relating to potential client leads (e.g., unassigned lead web part 510), while a field technician may not even have access to view this web part 510. Similarly, for a particular user to perform other actions, such as add, edit, delete, etc. in a web part, the user must be provided with that object permission. In this way, the intermediary access system solves problems described above in the Background of the Invention by providing only pertinent views of information (i.e., web parts 510) to the users. Such object permissions for the web parts 510 can be implemented with the interface discussed previously with reference to FIG. 3.

As discussed in detail herein, the information of the web parts 510 is communicated to the user with a data communication system, which connects application specific remote data sources at the enterprise system to communication devices of the users via an internet-based server of the intermediary system. An interface is provided by the intermediary system for extracting data from the user-defined data sources. The extracted data is then connected into specific objects (i.e., the web parts 510) and presented to the communication device of the user by personalized application templates.

The interface 500 shown in FIG. 9 represents one of the user's views of his/her personal, public, and shared data for the enterprise. The entire enterprise or each user or groups of users can have their own personalized enterprise views of data. The interface 500 and other interface of the disclosed system disclosed herein allow users to connect to such data such as: email, calendar, contacts, to do lists, notes, sales force automation (SFA), customer relationship management (CRM) and enterprise resource planning (ERP) systems. The interfaces of the disclosed system can be used with predefined data views based on user's roles in the enterprise, object permissions, time of communication, location of the user. Moreover, the interfaces of the disclosed system can be personalized to interface to the data content held in corporate applications such as Microsoft Exchange and Lotus Notes.

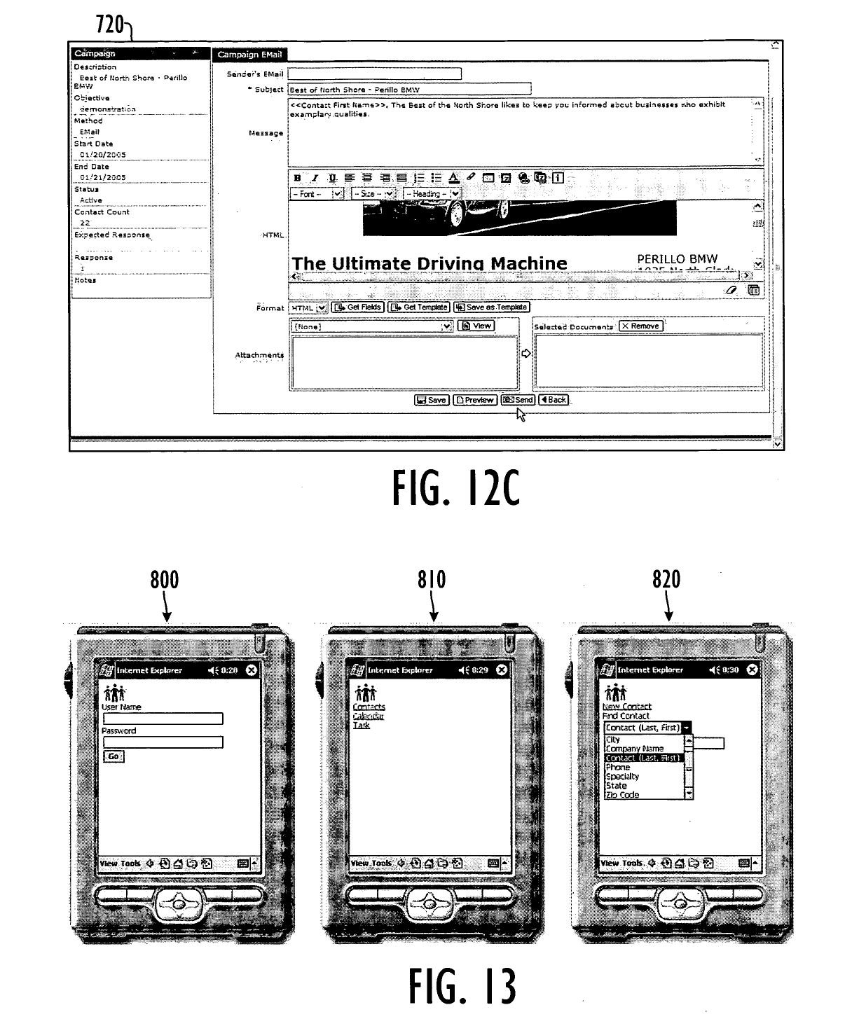

The interface 500 shown in FIG. 9 represents what a user may see when accessing the intermediary system with a laptop or desktop computer via the Internet or wireless connection. As such, this interface 500 is tailored for the communication device the user is using to access the information. If the user were accessing data with another device, such as wireless phone, PDA, or Tablet PC, the interface 500 would be tailored for those devices. Example interfaces on a PDA are discussed below with reference to FIG. 13, and an example interface on a wireless phone is discussed below with reference to FIG. 14. Therefore, the disclosed intermediary access system can have substantially the same user interfaces for mobile devices (i.e., a device specific generic interface for each unique type of device such as WAP phones, PDA's, laptop computers and telephones), just a different source of data.

Integration with third party ASP applications provides additional functionality to the disclosed system. For example, the additional functionality includes: embedding Legacy HTML created content and creating Profile specific information such as maps; product descriptions; photos, maps, group outbound messaging, alerts/notifications with acknowledgements; and lastly, data synchronization to enable migration from older technology solutions to the utility computing service of the disclosed system.

With mobile users viewing and entering data according to a predefined profile, the disclosed system offers a web part view of information that is familiar to the user. Application ‘views’ are presented to the user on mobile devices using device specific user interfaces for voice devices, wireless devices, and Web-enable devices. These applications are implemented using a variety of mobile markup languages (HTML, WML, HDML, VoiceXML) or using mobile SDKs. With the disclosed system, the application workflows based on user's profile, role, location, time and procedure offer real-time information delivery and superior ease of use and navigation. Once workflows are defined and the disclosed system is used, workflows remain consistent regardless of the source of the data.

Due to the modular nature of the disclosed system offered by the “Web Parts” 510, the disclosed system is able to provide services on an individual basis, so that a user or enterprise who is not interested in WAP connectivity, for example, does not need subscribe to it. This modular nature also allows for interchangeable content or on demand information based on GSM/EDGE network location, as discussed herein.

The disclosed system can include device specific navigational menus, such as ‘recently viewed’ items, that allow user's to readily access previous actions. This can reduce the number of keystrokes required to use wireless data applications and can facilitate the use of the disclosed system by voice recognition applications. For example, a user can use the status of a customer's shipped order to obtain a delivery time of the order.

Because the disclosed system is provided to enterprises on an ASP basis, the mechanisms for personalizing the presentation of information are already in place. The following section outlines several alternatives for building an enterprise view or user views (i.e., the overall representation of the data to users via their devices). The enterprise views may be originally built in the disclosed system or may come from linking to an existing website. In one example, enterprises are able to specify basic personalized views of the enterprise information. With this form of arrangement, personalization is performed automatically at the intermediary access system using “Set Up” fields, which were discussed above as elements 201 in the interface 200 of FIG. 3. Therefore, personalizing views of information by the users does not require any effort on the part of the IT department of the enterprise.

The disclosed system supports customization of various components of the enterprise view. The customizable components include, but are not limited to, graphics of the enterprise view, naming various items on the enterprise view, voice prompts, and object permissions. Custom site graphics can be positioned at the top, side, and/or bottom of a viewing page. In its simplest form, the site graphics can consist of a single image. Alternatively, HTML code can be used to produce presentations that are more complex. In either case, the enterprise is responsible for the supporting files (GIFs, JPEGs, Java applets) and HTML code.

The enterprise can customize naming of various fields, such as set up items and look up items, discussed previously with reference to elements 201 in the interface 200 of FIG. 3. The enterprise is able to specify/personalize their own language/names for various features and concepts in the site. For example, a given area of the enterprise view, which is a web part 510 of FIG. 9, can be named an address book, a “contact list,” or a “directory.” This form of customization is applicable for HTML, WML, and VoiceXML. In addition, the enterprise is able to customize all voice prompts for any voice interfaces. An API is provided that is based on open standards (XML and HTTP).

Furthermore, enterprises can also customize a set of configuration parameters, thereby enabling or disabling menu items, specific screens, access privileges, object permissions, etc. for a group of users or for individual users. This form of customization was discussed previously with reference to users and user groups of the interface 200 of FIG. 3. As noted above, object permissions define user-oriented objects of the system. User-oriented objects are internal objects, which track users' preferences (views, profile information, user's location, the date, the time, and resource tracking) and drive the functionality of the system so that intermediary server system can perform various user-oriented tasks. For example, a location object allows the disclosed system to send and receive users' data based on the time, the location of the user, the user's profile, the user's role or privileges in the enterprise, SMS Messages with reminder preference object allows system server to provide alerts to mobile users on particular, user defined communication channels at particular times. As a final example, credential objects allow the disclosed system to offer a Promotion, to verify Skills/Credentials, and to find a location of the user based on the user's GSM/EDGE network ID.

The disclosed system carries out the extraction of data from enterprise data stores to produce personal “views” of the data for the user based on Object Permissions/Customer Status privileges to access address books, calendars, resources, Lab Results, Insurance Verification, or Industry specific/personalized ‘views’. These ‘web parts’ 510 of FIG. 9 are built once for each application and reused. These tools can be though of as alternate forms of persisting objects.

As also shown in FIG. 9, the particular user can personalize his/her own enterprise view by accessing “personalize this page” 550 from the home interface 500 and from other various interfaces disclosed herein. For example, the user can access an interface to move the location of web parts, to delete web parts, or to restore default web parts for the interface 500 of FIG. 9, and the user can access an interface to customize there personal information Recall that a user is allowed access to a predefined amount of information based on Location, Time, Role/Permissions, Company Status, etc. as assigned to the user so that the user typically cannot add more Web Parts 510 than those they are originally allowed permission to.

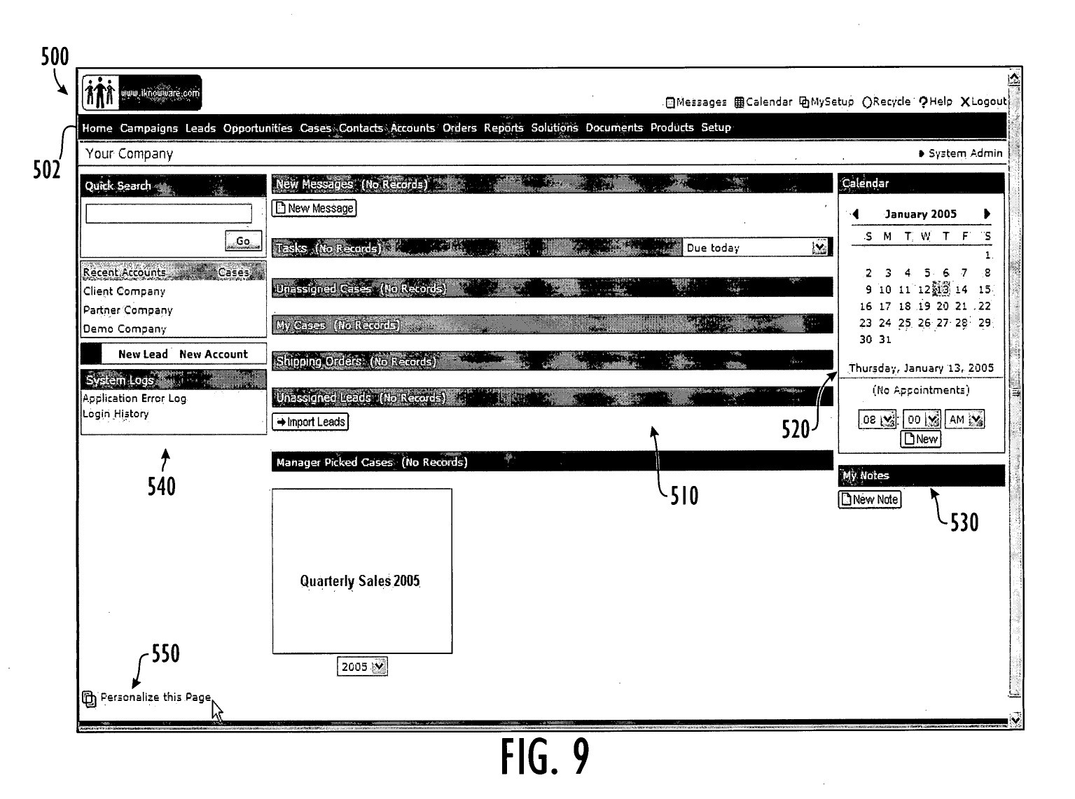

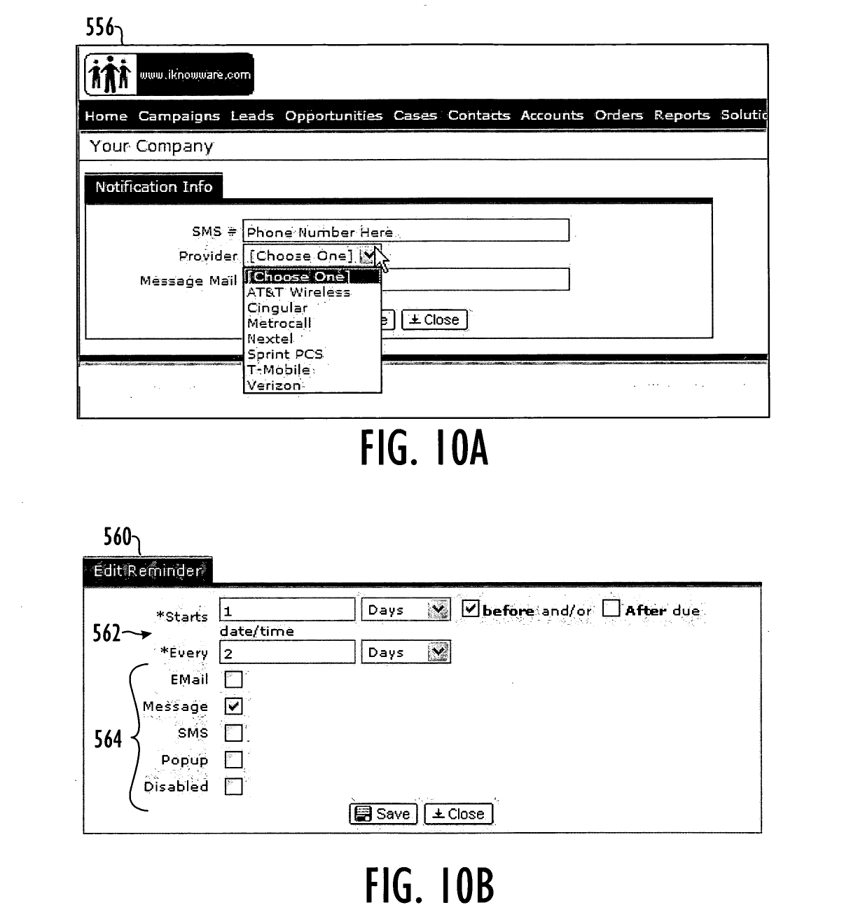

As part of the customization, the user can customize his/her notification information using an interface 556 shown in FIG. 10A. Not all users may be given access to notification capabilities. In the interface 556, the user can enter her SMS phone number at which she wishes to receive notifications. The user then selects her SMS message provider from a drop down, and enters the message mailing address (e.g., “phonenumber”@“provider.com”). The disclosed intermediary system is linked to her message provider via a communication link, such as the Internet, and the disclosed intermediary system can then send messages to the message provider, which in turn can send the message to her device using a wireless or cellular network.

As another part of the customization, the user can customize how alerts or reminders can be sent to one or more the her communication devices. The alerts and reminders can be for tasks, meetings, activities, scheduled items, and the like. In FIG. 10B, for example, an edit reminder interface 560 includes fields 562 for specifying when the user prefers reminders to be sent. Then, in fields 564, the user can select one or more notification rules or methods, including E-mail, message, SMS, or Popup. The reminder notifications can also be disabled. The messaging method for notification in fields 564 can correspond to messages sent to a VoIP-enabled phone that can display information pushed to it. The SMS method for notification include text messaging sent to a cellular phone or the like. Alternatively, if the user has a communication device that is not compatible with text messaging, the disclosed system can use a Text-to-Voice application to convert the message to voice to be relayed to the user's device. The Pop-up method for notification applies to when the user is actively viewing her personalized view via the Internet, and the reminder appears as a pop-up within the user's browser.

Although not shown in FIG. 10B, other notification methods that can be handled by the disclosed system include Fax, Multimedia Messaging (MMS), and voice messaging. For example, the disclosed system can send an e-fax to a user-specified fax number as the method of sending an alert or notification. In another example, the disclosed system can convert text of an alert or notification to voice using a text-to-voice application of the disclosed system and send the notification view a cellular network or the like to the user-specified cell phone number.

In the description that follows, various exemplary interfaces for the disclosed system are discussed. These various interface correspond to some of the “Web Parts” discussed above with reference to FIG. 9 and are discussed in the context of a given implementation, which corresponds to a typical business environment, such as product sales. One skilled in the art will appreciate, however, that the content of these various interfaces can be suited for any implementation and enterprise.

In one embodiment suitable for a business enterprise, the enterprise provides users with a “view” of enterprise data that provides various features, such as tasks, contacts, calendar, and messaging. In addition to providing these various features, the system allows for collaboration between these various features so that users can collaborate messaging, documents, discussions, contacts, and tasks in organized accounts without leaving the enterprise view. Because the “view” of enterprise data can be accessed and viewed by stationary and mobile users from various locations and times, the disclosed system facilitates the ability for user to share information. The disclosed system delivers collaborative information in real-time right where the users are located and using their devices (e.g., the user's desktop, WAP or Bluetooth-enabled mobile Phone, or PDA/Pocket PC device).

In a first example, the disclosed system can have a contact interface, which provides a view of contacts and related history of targeting prospects, producing interest-generating activities, capturing leads from the field and marketing activities, weighting opportunities, and proactively managing contacts. The records for the contacts are part of one unified database constantly updated with access/inputs of information from other departments of the enterprise. Contact entries need not be duplicated on several databases. The contact records are up-to-date and personalized.

In a second example, the disclosed system can have calendar interfaces, which give users a view of their calendar from the user's workplace, house, wireless phone, or PDA/PocketPC, for example. Because the enterprise view provides real-time information of user's tasks, contacts, and appointments, the built-in permission of the system allows one user to share their calendar with colleagues who need to know their schedule, while maintaining the privacy of personal meetings.

In a third example, the disclosed system can have appointment interfaces, which allow user to directly create appointments for themselves. Alternatively, appointments are tracked and automatically updated from tasks. Tracking appointments is very productive in letting others “know” if the user is available as a resource to others. This eliminates the many phone calls, e-mails, searches for available equipment/resources. At a given time, a user will have knowledge of all available personnel, resources, equipment, products, etc.

In a fourth example, the disclosed system can have task interfaces, which allows a user to keep track of personal action items as well as delegate tasks to colleagues, department employees, or members of a project team. Users can follow the progress of a task from start to completion and view status by owner, task, case or other criteria. In a fifth example, the disclosed system can have internal messaging interfaces, which allow a user to use secure internal messaging from their workplace, home, wireless phone, PDA/PocketPC, and etc. The internal messaging also allows other users to send a personal message to the users enterprise view and update any new information on a contact, task, or calendar/schedule event. Call Recording in the form of “.wav” files can be stored and attached to entries for contact, task, calendar/schedule event, or call logs. This enables the users to store messages for replay and annotate voice messages. The messages can be played over the user's communication devices, such as PC, Smartphone, and Wireless PDA, and the message can be forwarded as wave file attachments using internal Messaging or third-party e-mail interfaces.

In a sixth example, the disclosed system can have e-mail messaging interfaces, which allow a user to e-mail from their workplace, home, wireless phone, PDA/PocketPC, etc. In a seventh example, the disclosed system can have product related interfaces, which allow a user to access information on products from their workplace, home, wireless phone, PDA/PocketPC, etc.

In an eighth example, the disclosed system can have custom reports interfaces, which allow users to list collected data in a way they choose. By selecting a desired data field, the user can generate reports that list and organize information in a way that makes it easy to understand. The system may come with pre-generated standard reports pertinent to a given enterprise, and the custom reports interface allows users to format and organize information as desired.

In a ninth example, the disclosed system can have various interfaces, which allow users to enter and access information on leads, opportunities, orders, job requests, accounts, referrals, call logs, and letters from their workplace, home, wireless phone, PDA/PocketPC, etc. With regard to leads, the disclosed system can have a web-based lead capture feature. In the Internet age, prospective customers often visit an enterprise's website to learn about products and services. Often, customers send contact information to the enterprise website. The web-based lead capture feature allows the enterprise to import data collected from their website. The capture feature takes these captured leads and presents the information to a person who can either field the concern or pass it to someone who can follow up on such leads.

In a tenth example, the disclosed system can have interfaces for tracking solutions and resources, which allow the users to generate and track answers to problems and to track resources. The solution tracking interface, for example, allows users to quickly create a standardized response allowing for management to fine tune answers to customer's problems. The solution tracking interface also enables users to create a digital library of answers for their customers that can be accesses from a case view interface and accounts view interface, which are both disclosed herein. By accessing the solution tracking view, the user can retrieve previously produced solution when generating email, outgoing telephone calls, letters, faxes, and notes allowing for quick, accurate, supporting responses, for example.

The resource interface, for example, allows users to track and coordinate service technicians, equipment, etc. with various activities, job requests, and appointments. Details on the resources, such as skill sets and certifications on a service technician, can be entered and used for searching for a suitable technician for a particular task.

In an eleventh example, the disclosed system can have document management interfaces, which serves as an internal document bank for electronic literature of the enterprise. The document management interface allows the enterprise to disseminate information, such as expert articles, standardized documents, marketing literature, and custom sales reports, to users. The document management interface in the system offers an intuitive interface to makes this information of management as simple as clicking on a link in a web browser your company saves printing, postage, material collation and distribution cost each day.

Among other interfaces of the disclosed system, the user can review her log-ons to the system in which the various machine IP's for the devices the user has used to access the disclosed system are provided. In another interface, for example, the user can customize document templates. These document templates may represent typical documents the user may use repeatedly in the course of their duties. Attachments can be added to the templates, and fields for the templates can be imported. The ability to create such templates can facilitate the mobile user when they are in the field and are using a mobile device.

The disclosed system can have a document broadcast service, which operates much like the document interface described above. The document broadcast service allows users to disseminate knowledge and information to internal staff. The document broadcast service allows the user to disseminate information to individuals and groups outside of the organization. The document broadcast service enables individuals to send out documents generated internally to customers outside the enterprise. For example, often specifications and manuals are written and updated and customers need to be notified of these updates and changes. The document broadcast service facilitates sending out customer documentation updates. In addition, the system allows the user to choose and designate users to own ‘view and send’ privileges to release the enterprise information to customers.

In addition to the interfaces described above, the disclosed system can have account/case interfaces, which enable users to organize and track relationships with clients. In the disclosed system, each client can be associated with an account. It is in this framework that client transactions, correspondence, and action requests are tracked from their creation to resolution. The tracking of action requests give managers in the enterprise a clear view of how problems are being handled in the enterprise. In the system, any of a number of items or issues can be considered a “case.” For example, a case can be a product malfunction, service request, customer question, suggestion, or requests.

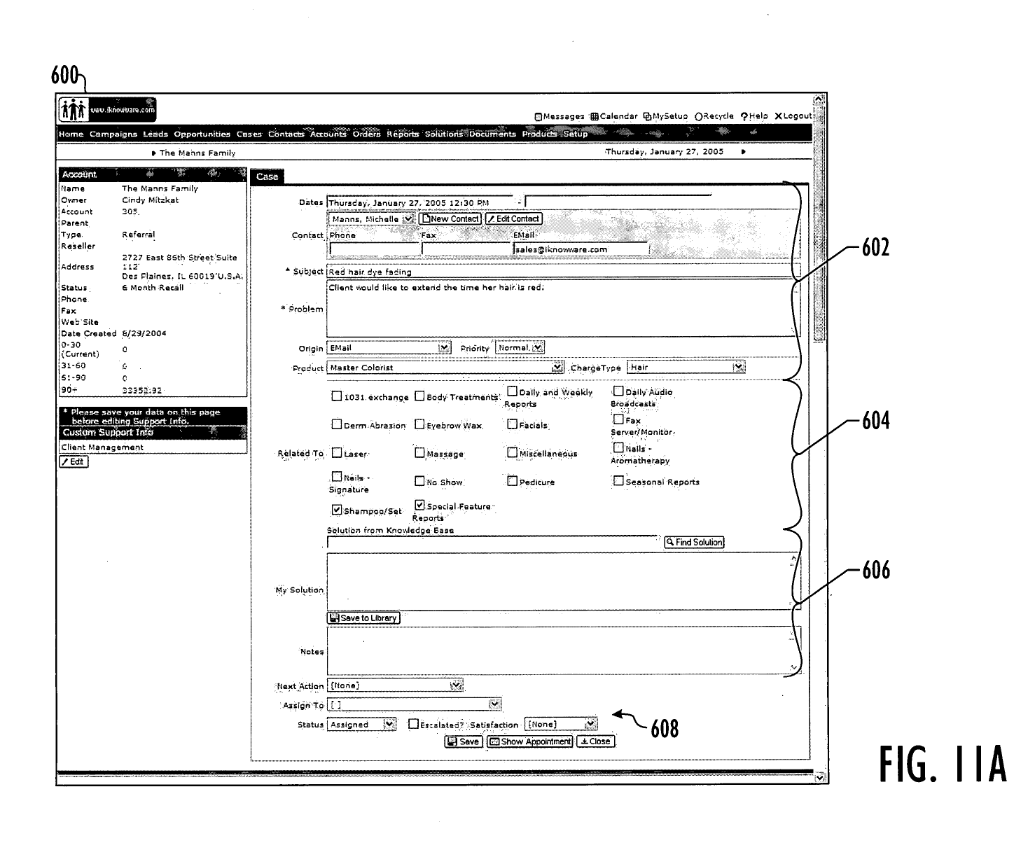

As best shown in the interface 600 of FIG. 11A, each case can be personalized toward a company, industry, field, or service. The fields 602 through 608 of the case interface 600 can also be personalized so that the case can be designed to manage a particular problem, issue, account, job, etc. The interface 600 can include fields 602 that define the case, such as date, contact, subject, problem, origin of correspondence, priority of case, product associated with case, etc. The interface 600 can include fields 604 that relate the case to other cases, categories, or items, which can be also personalized. The interface 600 can include fields 606 that pose a solution for the case, which can be added to or taken from a stored knowledge base of solutions. In addition, the interface 600 can include fields 610 that assign next actions to the case, assign a person to handle the case, etc.

In a typical business environment, for example, customers are an endless source of comments, questions, and issues. The case management interfaces, such as interface 600, in the disclosed system gives users a tool to track these concerns and the dialog between the enterprise and client on a particular issue or case. The case management interface 600 allows the user to assign cases to the person in the company who can resolve a problem quickly and accurately, ensuring the customer's satisfaction.

As best shown in FIG. 11B, the case management interface 650 allows the user to comment, track resolution time, and archive the transaction for later review. The interface 650 allows the user to associate various items with a case. The associated items include the case description 652, contacts 654, activities 656, tasks 658, attachments 660 (e.g., documents, faxes, letters), appointments 662, and Messages/Discussions 664. Correspondence from E-Mail, Fax, Telephone, plain postal letter, SMS message, etc. can be traceable and available to the entire user base with access to the case. All Messages and Discussions can be ‘linked’ or attached to the case using an “Associate” message function 666. The attached messages form a “Blog” or thread of correspondence related to the case that can be reviewed.

In addition to the interfaces described above, the disclosed system can have publishing interfaces, which enable users to communicate information to others by way of the Internet. The publishing interfaces can allow the users in the enterprise to push different documents, communicate produces, and manage solutions.

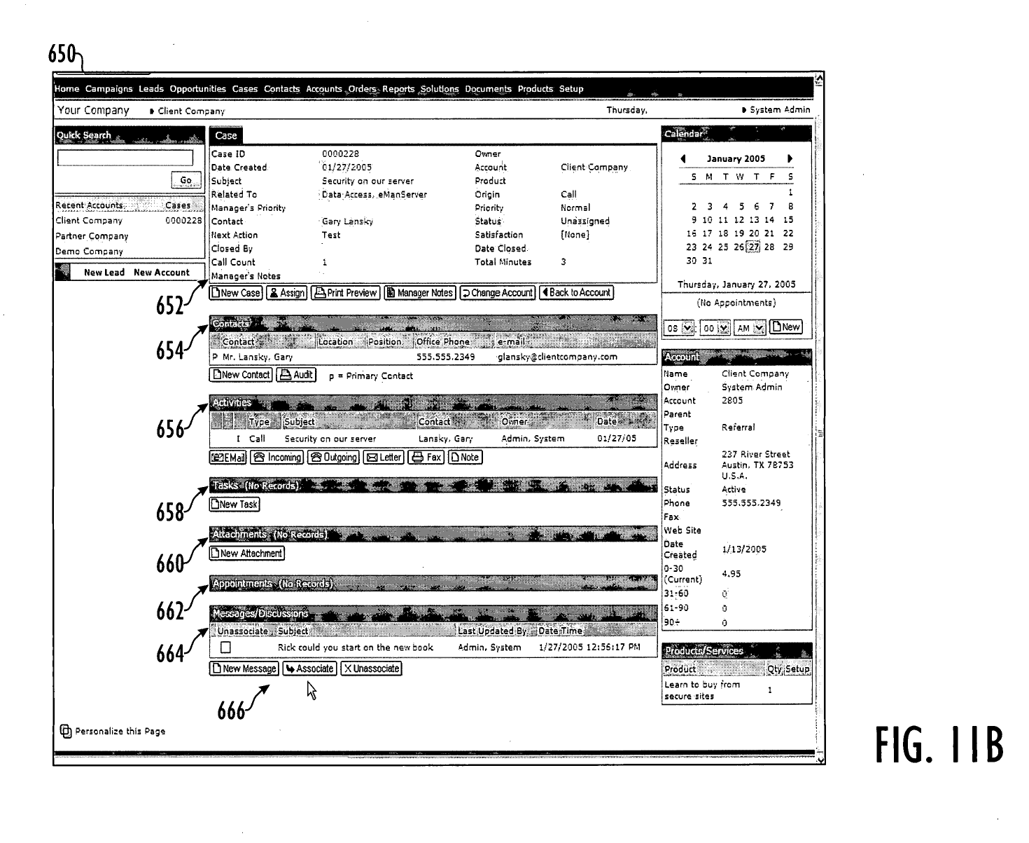

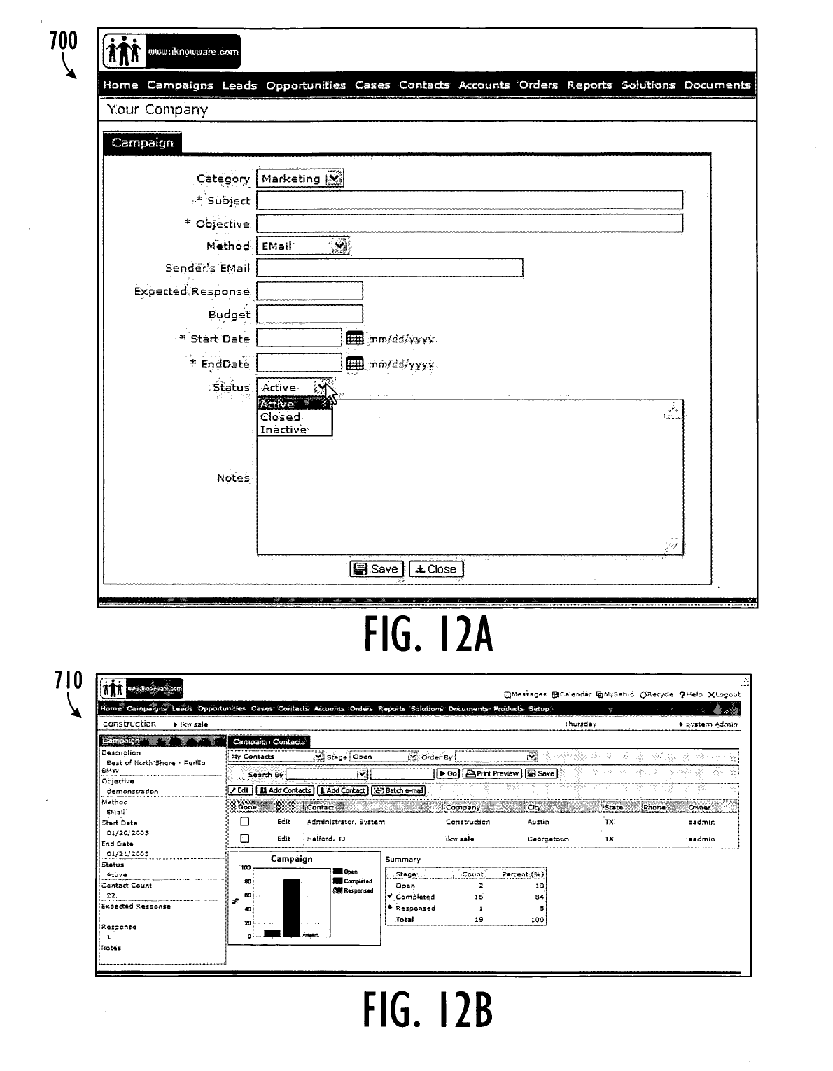

In addition, the publishing interface can be used for “Campaigns,” such as shown in FIGS. 12A-12C. The campaign interfaces of FIGS. 12A-12C allow users to select contacts of the campaign, to construct the communication to send to the contacts, and track the progress of sent communications and received responses. In a first campaign interface 700 of FIG. 12A, for example, a user can set up a marketing, development, etc. campaign for selling a product, performing a service, confirming registration, training personnel, etc. In a second campaign interface 710 of FIG. 12B, for example, the user can select contacts for receiving information associated with the campaign. The contacts can be selected based on their location, roles, privileges, or their relationship to the enterprise, among other possibilities. Once the campaign is set up and contacts have been selected, the user can implement the campaign using any of the various communication interfaces of the disclosed intermediary access system, such as fax to e-mail, e-mail to fax, printed letters, phone calls via an automated Call Center, or e-mails. For example, a third campaign interface 720 of FIG. 12C allows the user to construct a campaign e-mail by entering the user's (i.e., sender's) e-mail, a subject, a message, HTML content, and attachments.

As discussed previously, the intermediary access system of the present disclosure has wireless communication interfaces for communicating with wireless devices. Using the wireless interfaces, for example, a user can access tasks, contacts, calendar, and other features of the disclosed system while traveling or away from their office. All the various actions that the mobile user performs while traveling are reflected in the user's stored enterprise view. Therefore, users have no need of synchronizing mobile devices with a central storage of the enterprise system.

As also discussed previously, the access or “view” of enterprise data available to a user may be limited or tailored in part by the device the user is using to access the disclosed system. For example, a user accessing the disclosed system with a WAP-enabled PDA or pocket PC may have a view of some of the various web parts configured for the user that are tailored to the PDA. FIG. 13 illustrate exemplary wireless interfaces 800, 810, and 820 for a PDA or pocket PC. The first interface 800 is used to log-in to the disclosed system with the device. The second interface 810 has a menu of enterprise information available to the user. The information can be limited or tailored by the device being used, the access privileges of the user, the role of the user in the enterprise, the location of the user, the time the user is accessing the disclosed system, and other criteria disclosed herein. The third interface 820 shows a menu that allows the user to add or access a contact. FIG. 14 illustrates an exemplary interface 830 for a user to log-in to the disclosed intermediary access system using a wireless telephone.

Using the interfaces of FIGS. 13-14, for example, the users can establish a secure message link to contacts, find contact numbers, check on upcoming events and appointments, and view details of meetings (such as subject, location, and attendees). The users can keep track of deliverables and tasks with the wireless interface. The wireless interface can access high-speed wireless data connections within wireless networks, such as the AT&T Wireless GSM/GPRS or Verizon Wireless networks. The wireless interface allows users to manage and customize the way they receive information on their wireless devices. Examples of suitable devices for connecting to the wireless interface include an AT&T Wireless Next Generation or Verizon Wireless device and data plan for capable WAP enabled phones, wireless PDAs, and wireless-enabled laptops using a wireless PC modem card or tethering cable.

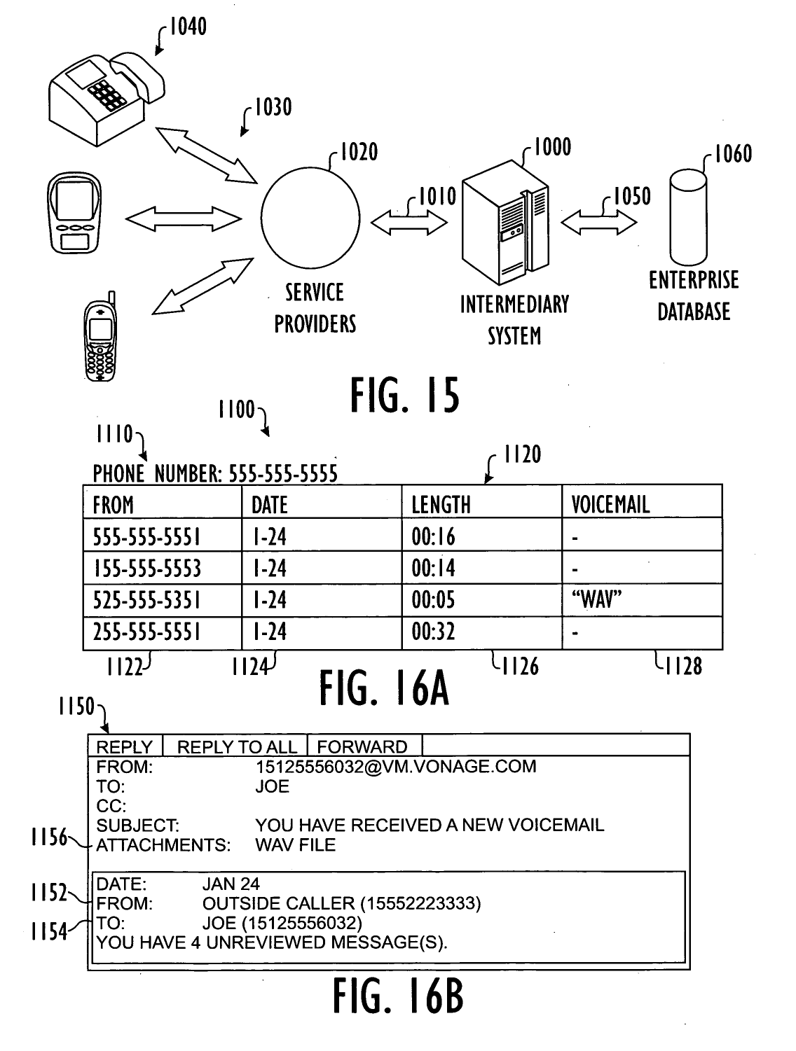

In addition to the aspects of the system disclosed above, the disclosed intermediary server system includes applications that have various automated features for handling call-related information. Referring to FIG. 15, the disclosed intermediary system 1000 is schematically illustrated. The disclosed intermediary system 1000 is connected to one or more third party communication providers 1120 by one or more communication links 1110, which in some embodiments can include Electronic Data Interchange (EDI) feeds and Internet connections. As discussed previously, the disclosed intermediary system 1000 is also connected to an enterprise database 1160 via one or more communication links 1150.

The communication providers 1120 provide service to a number of communication devices 1140 for users in the enterprise using one or more communication links 1130, such as Internet, Wi-Fi, and cellular connections. For example, these communication devices 1140 can include IP phones, such as those available from Alcatel, Avaya, Cisco, Siemens, Polycom, etc. These devices 1140 can also include PDAs, PocketPC devices, RIM BlackBerry devices, WAP-enabled cell phones, and IP endpoints.

Not only are some of these devices 1140 useful for mobile users in the enterprise, but the IP phones, for example, may be useful in environments where computers cannot be used or are not typically used. Such environments include warehouse docks, remote office locations, factory floors, retail sales floors, public reception areas, etc. As discussed above, the application of the disclosed intermediary system 1000 allow users of the various devices 1140, such as IP phones, PDAs, WiFi cell phones, etc) to access and view enterprise data as “Web Parts.” To do this, applications of the disclosed intermediary system 1000 uses HTML, XHTML, XML, and WML protocols and languages.

To handle call-related information, the disclosed intermediary system 1000 can perform some of the following function. Using Caller ID, the disclosed system 1000 can recognize and validate a user's privileges for accessing data in the enterprise database 1160. The disclosed system 1000 can capture the number of a phone call and associate that call to a particular contact, account, project, task, lead, or other area of data in the enterprise database 1160 related to the phone number. In addition, the disclosed system 1000 can handle the routing of inbound/outbound communications of Fax documents and can handle the routing of “wav” files for voice mail messages.

In one embodiment, the disclosed system 1000 includes XML-based applications that receive call information from the service providers 1120. For example, as part of the user's service arrangement with a service provider 1120, call-related information can be sent from the service provider 1120 to the disclosed system using an EDI feed or e-mails.

For example, FIG. 16A illustrates an example in tabular form of call-related information 1100 sent by an EDI feed from a service provider to the disclosed system. The format of the information 1100 may depend of the service provider. In this example, the information 1100 can include the target phone number 1110 and a listing of incoming calls. The listing 1120 can include the number 1122 where the incoming call originated, the date 1124 of the call, the length 1126 of the call, and any voice mail information 1128. The voicemail information 1128 can include a “wav” file recorded during that call. It will be appreciated the listing of calls can alternatively include outbound calls that the originating phone number 1110 has made.

In another example, FIG. 16B illustrates an example of call-related information sent by an E-mail 1150 from a service provider to the disclosed system. The disclosed system parses the E-mail 1150 and extracts the target phone number 1152 and the sending phone number 1154 to determine where to assign the call. The disclosed system can also obtained the attached voice mail “wav” file 1156 and assign it appropriately for the user.

Returning to FIG. 15, the call-related information discussed above can be sent periodically from the service providers 1020 to the disclosed system 1000 using the EDI feed, E-mails, or other communication link 1010. Applications at the disclosed system 1000, which can be HTML and/or XML-based, parse the call-related information received. Then, the disclosed system 1000 identifies the target number (1110) and the caller number (1122) and assigns the call to a contact, an activity, an account, a task, a call log, or other enterprise related information based on a comparison of the numbers to information stored at the disclosed system 1000 or the enterprise database 1060.

For example, the disclosed system 1000 can be configured to review calls received for a user that exceed some predetermined amount of time. Based on the target phone number (1110), the disclosed system 1000 determines which of the user to apply the information. Based on the incoming phone number (1122), the disclosed system 1000 then determines which contact, account, task, or other domain or “Web Part” of the user's personalized view that the number belongs to. This determination can be configured by the user based on various rules. Once the determination is made, the disclosed system 1000 automatically updates the contact, account, task, or other related domain or “Web Part” stored at the disclosed system 1000 or the enterprise database 1160 with the call-related information.

By capturing caller ID, the disclosed system 1000 can automatically import, capture, and synchronize the caller's information into a user's Lotus Notes®, Outlook®, and Palm™ directories. The user may have more than one phone line (e.g., mobile phone, landline phone, and call center ID). Whether the user has one phone line or multiple, the user can still have her calls captured using the Caller ID. The captured calls can then be associated with Call Logs based on rules, preference, roles, etc. assigned or configured for the user.

In addition, because the disclosed system 1000 is connected to a third party service provider 1020 that may record voice mails, the user can listen to attached “wav” file voicemails and can forward voice mails as “wav” files to others using the disclosed system 1000. Furthermore, the disclosed system 1000 can obtain the GPS coordinates or the GSM mapping of a caller's or user's location from a third party service provider 1120 having those capabilities.

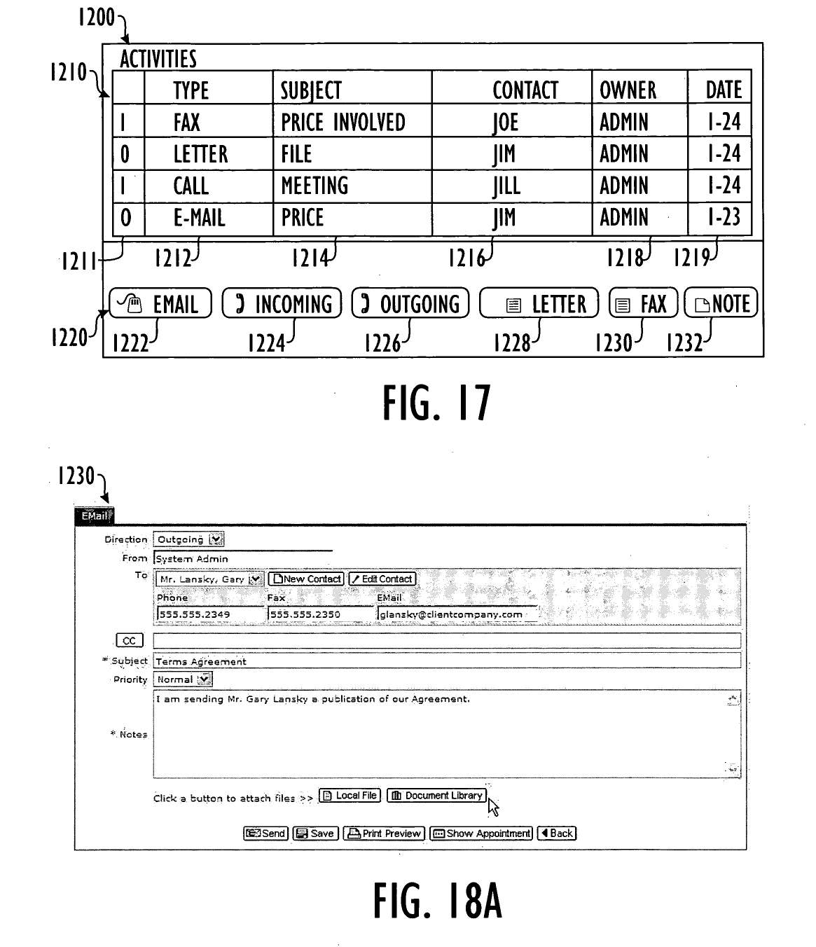

FIG. 17 shows an example of how the disclosed system can associate call-related information to a domain or “Web Part” of the disclosed system. In this example, the call-related information is associated with Activities “Web Part” 1200 of a user of the enterprise, but the information could be related to other “Web Parts,” such as Accounts, Tasks, Projects. The Activities “Web Part” 1200 can be part of the home interface of the user as discussed above with reference to FIG. 9. The Activities “Web Part” 1200 can be accessed by any of the various communication device that a user can utilize to connect with the disclosed system. Here, the Activities “Web Part” 1200 is shown in a format suitable for a Web-enabled or WAP-enabled device for illustrative purposes, but the Activities “Web Part” 1200 can have other formats suitable for the user's device.

The Activities “Web Part” 1200 list various communication activities, including faxes, letters, calls, and e-mails, associated with the user. The listing includes the following columns: Incoming/Outgoing 1211, type 1212, subject 1214, contact 1216, owner 1218, and date 1219. Selecting one of the entries in the list can bring up additional information related to the entry. The entries can be manually input by the user or can be automatically added by the disclosed system.

As shown in the type column 1212, an incoming call is listed as one of the activities. This incoming call can be automatically associated to the contact 1216 and added to the Activities “Web Part” 1200 for the particular user based on the techniques discussed above for automatically handling call-related information from a service provider. As noted previously, the call-related information can include voice mail massages as “wav” files and these voice mail messages can be automatically associated with the user' activities. Then, using any of the various communication devices, the user can play that voice mail message using her computer, Smartphone, Wireless PDA, etc. when accessing her Activities “Web Part” 1200 of the disclosed system with her communication device. In addition, the user can forward her voice mail messages as “wav” file attachments to others using internal messaging or E-mail capabilities of the disclosed system. Furthermore, the user can download the voice mail messages from the disclosed system to an MP3 player, iPod, or similar device, for example, so the user can play the messages on the device.

Listing calls, E-mails, etc. in the Activities “Web Part” 1200 for the user can be useful for billing purposes, reviewing work performance, or other reasons appropriate for an enterprise. In one example, service technicians or salespersons typically will not or cannot enter information in their Activities “Web Part” 1200 when they are in the field. Using the automated features of the disclosed system for handling call-related information, any call activities or other “Web Parts” for the service technicians or salespersons can be pre-populated based on Caller ID.

Just as the calls can be automatically associated with contacts, accounts, tasks, and activities, so can E-mails, faxes, and letters in much the same manner. For example, when the user sends an E-mail or a fax, the disclosed system can automatically associate the E-mail or fax with activities, contacts, tasks, or other “Web Parts” of the user's personalized view by parsing information in the headers, such as e-mail addresses, fax numbers, etc. Likewise, incoming e-mails or faxes can be automatically associated with activities, contacts, tasks, or other “Web Parts” of the user's personalized view in the same way.

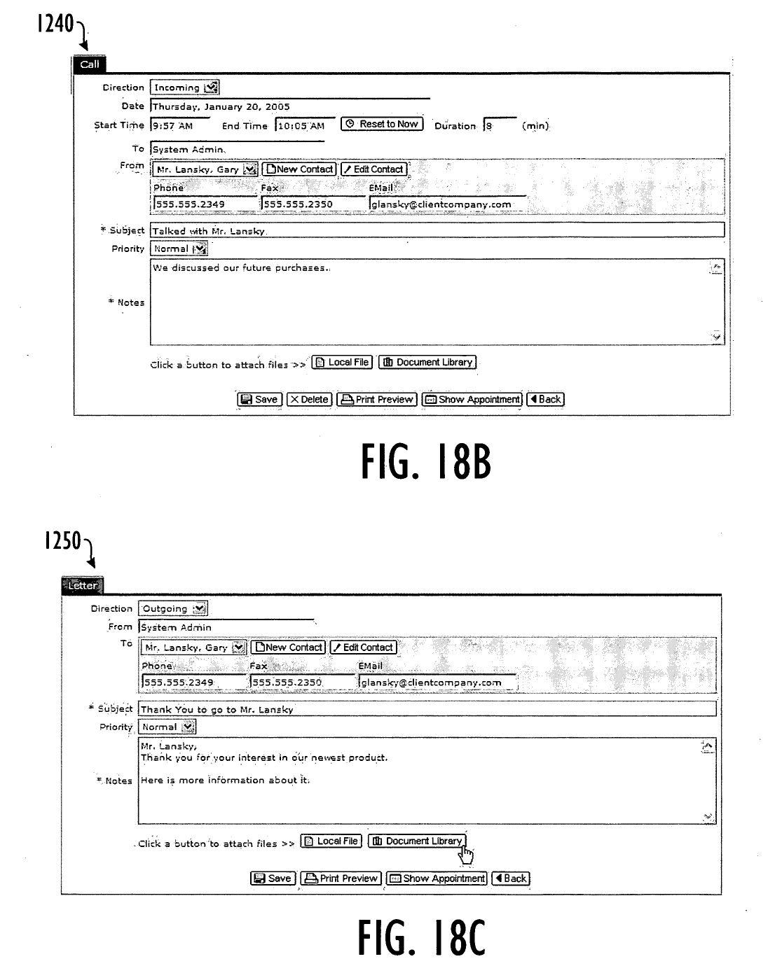

For example, the Activities “Web Part” 1200 shown in FIG. 17 has a number of activity functions 1220, including Email 1222, Incoming Call 1224, Outgoing Call 1226, Letter 1228, Fax 1230, and note 1232. By selecting the E-mail function 1222, the user can access the interface for constructing an E-mail and have the sent E-mail added to the list of activities. (One example of the E-mail interface 1230 is shown in FIG. 18A.) By selecting the functions for Incoming Call 1224 or Outgoing Call 1226 of FIG. 17, the user can access the interface for manually entering an incoming/outgoing call and have it added to the list of activities. (One example of a Call interface 1240 is shown in FIG. 18B.) By selecting the Letter function 1228 of FIG. 17, the user can access an interface for constructing letter and have the sent letter added to the list of activities. (One example of a Letter interface 1250 is shown in FIG. 18C.)

With respect to the Fax Function 1230 of FIG. 17, the user can use the disclosed system to send e-faxes via the Internet and third party e-fax service providers. When selected, an interface similar to the E-mail interface disclosed above is accessed. The user can enter fax numbers, subject, messages, and attach files. When sent, the outbound fax is added to the activities list and can include an attachment of faxed documents.

With respect to inbound faxes, the user may have a toll free fax number associated with a e-fax service. When an inbound fax is received by the service, the inbound fax is sent as an e-mail to the disclosed system. When received, the disclosed system parses the header information of the e-fax e-mail to determine the user, account, task, or other part of the user's personalized view that the fax should be associated with. For example, an entry indicating the inbound fax can be added to the Activities “Web Part” as shown in FIG. 17. The fax documents of the inbound fax can then be attached to the entry so that the user can access the documents using the disclosed system.

As evidenced by the present disclosure, the disclosed intermediary system enables users to access a wide variety of enterprise information from a number of communication devices, including, but not limited to, handheld wireless Phones, wireless Personal Digital Assistants (PDA), IP phones, etc. The disclosed intermediary system tailors the user's access to pertinent enterprises information based on the user's assigned role in the enterprise, the user's privileges in the enterprise, the location of the user in a network, or the point in time when the user access the disclosed system. Based on pre-defined viewing roles and access privileges, the disclosed system allows the user to perform real-time tasks (e.g., view lab results, make orders, update inventory) without having to navigate or access a complex database system maintained by the enterprise, such as an institution, company, hospital, etc. Finally, the disclosed system allows for sharing and real-time reporting of user-specific or enterprise-specific information (E-mails, calls, faxes, orders, inventory, activities, tasks, meetings, etc) that has been stored by a user or others known to the user.

The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. An enterprise data access method, comprising:
configuring access privileges for a plurality of users, the access privileges defining enterprise data that the users can access;
establishing connections with communication devices of the users;
determining the access privileges for the users based on the connections;
retrieving data for the users defined by the access privileges; and
delivering a personalized view of retrieved data to the users by tailoring retrieved data to types of the communication devices of the users, locations of the users in a network or a system, or points in time when the users establish connections.

2. The method of claim 1, wherein tailoring retrieved data to locations of the users in a network or system comprises tailoring retrieved data based on a location of the communication device of the user in a network or a system.

3. The method of claim 2, wherein the network or the system comprises a Global System for Mobile (GSM) communications/Enhanced Data rate for GSM Evolution, Global Positioning System, or a Geographic Information System.

4. The method of claim 1, wherein the enterprise data comprises one or more of: Enterprise Resource Planning data, Finance and Operations data, Customer Relationship Management data, Supply Chain Management data, Knowledge Management data, and Associate Message Functions.

5. The method of claim 1, wherein one of the communication devices comprises a voice-enabled communication device, and wherein delivering a personalized view of retrieved data to the users by tailoring retrieved data to the types of communication devices of the users comprises delivering retrieved data with an interactive voice recognition session tailored to the voice-enable communication device.

6. The method of claim 1, wherein one of the communication devices comprises a Web-enabled communication device, and wherein delivering a personalized view of retrieved data to the users by tailoring retrieved data to the types of communication devices of the users comprises delivering retrieved data with one or more Hypertext Markup Language interfaces tailored to the Web-enable communication device.

7. The method of claim 1, wherein one of the communication devices comprises a Wireless Application Protocol-enabled communication device, and wherein delivering a personalized view of retrieved data to the users by tailoring retrieved data to the types of communication devices of the users comprises delivering retrieved data with one or more Wireless Markup Language interfaces tailored to the Wireless Application Protocol-enabled communication device.

8. The method of claim 1, wherein one of the communication devices comprises a server, and wherein delivering a personalized view of retrieved data to the users by tailoring retrieved data to the types of communication devices of the users comprises delivering retrieved data with one or more Extensible Markup Language interfaces tailored to server-to-server communications with the server.

9. The method of claim 1, wherein tailoring retrieved data to the points in time when the users establish connections comprises determining what retrieved data is pertinent to the points in time when the users establish connections, the pertinent data comprising message, contact, task, appointment, activity, account, product, or order information related to the points in time.

10. The method of claim 1, wherein the communication devices are selected from the group consisting of an Internet enabled computer, an Internet enabled laptop, a wireless Personal Digital Assistant, a Tablet PC, a wireless phone, a SmartPhone, a Voice over Internet Protocol Phone, or a landline phone.

11. A system for accessing data in an enterprises database, comprising:
a plurality of communication interfaces;
a system database storing access privileges, the access privileges defining enterprise data that the users can access; and
a server system operatively coupled to the communication interfaces and to the system database, the server system configured to:
validate connections of users connecting with communication devices to the communication interfaces;
determine the access privileges for the users from the system database based on the validated connections;
retrieve data for the users from the enterprise database, the retrieved data defined by the access privileges for the users;
tailor retrieved data to types of the communication devices of the users, locations of the users in a network or a system, or points in time when the users establish connections; and
provide tailored data to the communication devices of the users via the communication interfaces.

12. The system of claim 1, wherein the data of the enterprise databases comprises one or more of Enterprise Resource Planning data, Finance and Operations data, Customer Relationship Management data, Supply Chain Management data, Knowledge Management data, and Associate Message Functions.

13. The system of claim 11, wherein the communication systems comprise components, servers, or applications for communications selected from the group consisting of cellular, wireless, Web Application Protocol, Fax-to-E-mail, E-mail-to-Fax, E-mail, Short Message Service Messaging, Internet, Voice-to-Text, Text-to-Voice, Interactive Voice Recognition, Voice over Internet Protocol, Outbound Dialing, speech processing, and Enhanced Data rate for GSM Evolution (GSM/EDGE).

14. The system of claim 11, wherein the communication devices are selected from the group consisting of an Internet-enabled computer, an Internet-enabled laptop, a wireless PDA, a Tablet PC, a wireless phone, a SmartPhone, a VoIP Phone, or a landline phone.

15. The system of claim 11, wherein to validate connections of users connecting with communication devices to the communication systems, the server system is configured to identify the user based on network identifications for Global System for Mobile (GSM) communications/Enhanced Data rate for GSM Evolution.

16. The system of claim 11, wherein to tailor retrieved data to the locations of the users in a network or a system, the server system is configured to determine locations of communication devices in a Global System for Mobile (GSM) communications/Enhanced Data rate for GSM Evolution network, a Global Positioning System, or a Geographic Information System.

17. The system of claim 11, wherein one of the communication devices comprises a voice-enabled communication device, and wherein to provide tailored data to the voice-enabled communication device, the server system comprises a voice server conducting an interactive voice recognition session.

18. The system of claim 11, wherein one of the communication devices comprises a Web-enabled communication device, and wherein to provide tailored data to the Web-enabled communication device, the server system comprises a Web server generating one or more Hypertext Markup Language interfaces.

19. The system of claim 11, wherein one of the communication devices comprises a Wireless Application Protocol-enabled communication device, and wherein to provide tailored data to the Wireless Application Protocol-enabled communication device, the server system comprises a Wireless Application Protocol server generating one or more Wireless Markup Language interfaces.

20. The system of claim 11, wherein one of the communication devices comprises a server, and wherein to provide tailored data to the server, the server system comprises an exchange server generating one or more Extensible Markup Language interfaces for server-to-server communications.

21. The system of claim 11, wherein to tailor retrieved data to the points in time when the users establish connections, the server system is configured to determine what retrieved data is pertinent to the points in time when the users establish connections, the pertinent data comprising message, contact, task, appointment, activity, account, product, or order information related to the points in time.

22. An information handling method, comprising:
receiving communication data from a communication service provider via an Enterprise Data Import feed or an E-mail,
obtaining one or more phone numbers from received communication data;
determining from the one or more phone numbers the user to which the received communication data applies;
determining a user domain of the determined user with which to associate the received communication data; and
associating information of the received communication data with the determined user domain.

23. The method of claim 22, wherein obtaining one or more phone numbers from received communication data comprises parsing received communication data for the one or more phone numbers.

24. The method of claim 22, wherein determining from the one or more phone numbers the user to which the received communication data applies comprise determining a destination phone number for an inbound call and a source phone number for an outgoing call.

25. The method of claim 24, wherein the user domain comprise an activity log for listing incoming and outgoing calls of the user.

26. The method of claim 25, wherein associating information of the received communication data with the determined user domain comprises listing an indication of the call in the activity log, the indication including the target phone number, the source phone number, a call duration, and a date.

27. The method of claim 22, wherein the communication service provider comprises an Internet faxing service, and where determining from the one or more phone numbers the user to which the received communication data applies comprise determining a destination fax number for an inbound fax and a source fax number for an outgoing fax.

28. The method of claim 22, wherein associating information of the received communication data with the determined user domain comprises storing a received attachment with the information for the user domain, wherein the received attachment comprises a sound file for a voice message or an image file for a fax message.
